(19) United States
(12) Patent Application Publication
(10) Pub. No.: US 2010/0015245 A1
(43) Pub. Date: Jan. 21, 2010

(54) Combination of Copper Cations with Peroxides or Quaternary Ammonium Compounds for the Treatment of Biofilms

(76) Inventors: Joe Harrison, Calgary (CA); Raymond Turner, Calgary (CA); Howard Ceri, Calgary (CA)

Correspondence Address: FULBRIGHT & JAWORSKI L.L.P., 600 CONGRESS AVE., SUITE 2400, AUSTIN, TX, 78701, US

(21) Appl. No.: 12/428,747

(22) Filed: Apr. 23, 2009

Related U.S. Application Data
(60) Provisional application No. 61/047,634, filed on Apr. 24, 2008.

(51) Int. Cl. A01N 59/20

(52) U.S. Cl. 424/615; 424/638; 424/613; 424/616

(57) ABSTRACT

The present invention relates to a method of inhibiting biofilms by combinations of antimicrobials, particularly with their synergistic activity against bioFilms. The antimicrobials include combination of copper ion and quaternary ammonium compound or combination of copper ion and peroxide. The invention also include methods for inhibiting biofilm-induced microbial corrosion or fouling.

### BACKGROUND OF THE INVENTION

The present application claims benefit of priority to U.S. Provisional Application Ser. No. 61/047,634, filed Apr. 24, 2008, the entire contents of which are hereby incorporated by reference.

### FIELD OF THE INVENTION

The present invention relates generally to the fields of microbiology and specifically directed to biofilm and planktonic susceptibility to heavy metals in combination with anti-microbials.

### DESCRIPTION OF RELATED ART

Biofilms are cell-cell or solid-surface attached assemblages of microbes that are entrenched in a hydrated, self-produced matrix of extracellular polymers. There is increasing recognition among life and environmental scientists that biofilms are a prominent form of microbial life that may cause many different problems, ranging from biofouling and corrosion to plant and animal diseases (Hall-Stoodley et al., 2004). As a result, there are now numerous studies in the literature describing biofilm susceptibility to single agent antimicrobial treatments and yet, despite this explosion of information, there are relatively few studies that have systematically examined biofilm susceptibility to combinations of antimicrobials. This gap in the knowledge is an important matter to investigate.

Recent findings suggest that the decreased susceptibility of biofilms is linked to a process of phenotypic diversification that is ongoing within the adherent population (Boles et al., 2004; Drenkard et al., 2002; Harrison et al., 2007; Lewis, 2007). This means that there are likely multiple cell types in single species biofilms that ensure population survival in the face of any single adversity. Therefore, treating biofilms with combinations of chemically-distinct antimicrobials might be an effective strategy to kill some of these different cell types.

Recently, several inorganic metal species have attracted attention as antibacterials since they exert time-dependent toxicities that kill biofilms in vitro (Harrison et al., 2005; Harrison et al., 2004; Harrison et al., 2007; Harrison el al., 2005; Kaneko et al., 2007) as well as Pseudomonas aeruginosa in vivo (Kaneko et al., 2007). This microorganism is well studied and suited for biofilm research, as P. aeruginosa biofilms are much more resilient to conventional forms of chemical removal and disinfection than their corresponding populations of planktonic cells (Hall-Stoodley et al., 2004; Harrison et al., 2007; Spoering et al., 2001). It is important to note that microbicidal concentrations of certain toxic metal species may be poisonous to higher organisms, and therefore, this hazard limits the choices and concentrations of inorganic ions that may be used as part of antimicrobial treatments. However, certain metal ions with relatively lower biological toxicities to humans and to the environment might still be useful in many products—including disinfectants, surface coatings, hard-surface treatments and topical ointments—particularly if combined with other reagents. A need remains for an effective, low toxicity method of inhibiting biofilms and biofilm-induced corrosion or fouling.

### SUMMARY OF THE INVENTION

Thus, in accordance with certain aspects of the present invention, there is provided a method of inhibiting a biofilm comprising contacting the biofilm with copper ion and a quaternary ammonium compound. Particularly, “inhibiting” is further defined as comprising reducing microaerobic growth of organisms in the biofilm (bacteriostatic), or killing organisms in the biofilm (bactericidal). In certain embodiments, inhibiting of the biofilm occurs in less than about four hours (less than 3 hours, less than 2 hours, less than or at about 1 hour, at about 30 mins, at about 10 mins; 10 mins to 4 hours; 30 mins to 4 hours; 1-4 hours, 2-4 hours), or longer than fours, e.g., 4-12 hours, 12-24 hours, or4-24 hours to achieve a syngergistic effect, e.g., of at least about 16-fold over each agent alone. Specifically, the following embodiments are contemplated: (a) the copper ion and the quaternary ammonium compound are provided in an amount that induces synergistic killing of organisms in the biofilm; and/or (b) the copper ion and the quaternary ammonium compound are provided in amount below that which either agent can effectively kill organisms in the biofilm as single agents; and/or (c) the copper ion and the quaternary ammonium compound are provided in amount that achieves biofilm sterilization.

Particular combinations of agents and concentrations are contemplated. For example, Polycide® and copper maybe used advantageously in ranges of 25-400 ppm Polycide® with 2-32 mM copper sulfate. In particular, about 25 ppm Polycide® with about 2 mM copper sulfate may be used to achieve synergistic killing of biofilms as defined herein. For other quaternary ammonium compounds, the combinations may be as follows:
Benzalkonium chloride (1.5 to 100 ppm)+copper sulfate (0.125 to 4 mM) more particularly, 1.5 ppm+4 mM copper sulfate, and 100 ppm+0.125 mM copper sulfate
   in particular, 1.5 ppm and 1 mM copper sulfate
Cetylpyridinium chloride (0.75 to 400 ppm)+copper sulfate (0.0625 to 4 mM) more particularly, 0.75 ppm+4 mM copper sulfate, and 400 ppm+0.0625 mM copper sulfate
   in particular, 200 ppm+0.5 mM copper sulfate
Cetalkonium chloride (3.125 to 400 ppm)+copper sulfate (0.0625 to 4 mM) more particularly, 3.125 ppm+4 mM copper sulfate, and 400 ppm+0.0625 mM copper sulfate
   in particular, 400 ppm+1 mM copper sulfate
Myristalkonium chloride (3.125 to 12.5 ppm)+copper sulfate (0.0625 to 4 mM) more particularly, 3.125 ppm+4 mM copper sulfate, and 12.5 ppm+0.0625 mM copper sulfate
   in particular, 3.125 ppm+1 mM copper sulfate
      Thus, ranges from 3-400 ppm quaternary ammonium compound and 0.0625 to 4 mM copper sulfate may be used to describe synergistic embodiments. In particular, as with Polycide®, 25 ppm of these quaternary ammonium compounds may be used with as little as 2 mM copper sulfate may be used to achieve synergistic killing of biofilms as defined herein.

The invention is also directed in certain embodiments to a method of inhibiting microbial biofilm-induced corrosion or fouling of a surface or machine comprising treating a surface biofilm or machine biofilm with copper ion and a quaternary ammonium compound. For example, the surface or machine is comprised in an oil and gas well drilling system, a heating-cooling system, a water filtration system, a medical device (surgical tool, dental tool), a countertop, a floor, or a food processing tool/equipment. Particularly, the method of treating a surface biofilm or machine biofilm comprises contacting the copper ion and the quaternary ammonium compound with the surface biofilm or machine biofilm for less than four hours, for example, about 10 minutes, about 30 minutes, about 1 hour, about 2 hours, about 3 hours, or about 4 hours. The surface biofilm or machine film may be immersed with the copper ion and the quaternary ammonium compound.

In a further embodiment, the invention is directed to a method of inhibiting a biofilm comprising contacting the biofilm with copper ion and peroxide for less than four hours, for example, about 10 minutes, about 30 minutes, about 1 hour, about 2 hours, or any number in between the foregoing, or about four hours, or longer than fours, e.g., 24 hours to achiever a better syngergistic effect, wherein copper ion is dissolved in an aqueous solution. Particularly, “inhibiting” is further defined as comprising reducing microaerobic growth of organisms in the biofilm (bacteriostatic), or killing organisms in the biofilm (bactericidal). In this instant method, the copper ion and the peroxide are provided in an amount that induces synergistic killing of organisms in the biofilm; and/or the copper ion and the peroxide are provided in amount below that which either agent can effectively kill organisms in the biofilm as single agents.

In another embodiment, the invention is also directed to a method of inhibiting microbial biofilm-induced corrosion or fouling of a surface or machine comprising treating a surface biofilm or machine biofilm with copper ion and peroxide for less than four hours, for example, about 10 minutes, about 30 minutes, about 1 hour, about 2 hours, or any number in between the foregoing, or about four hours, or longer than fours, e.g., 24 hours to achiever a better syngergistic effect. In certain aspects, the time for treating may be up to 24 hours. As described above, the surface or machine may be comprised in an oil and gas well drilling system, a heating-cooling system, a water filtration system, a medical device (surgical tool, dental tool), a countertop, a floor, a food processing tool/equipment, or paper or textile manufacturing equipment. The surface biofilm or machine film may be immersed with the copper ion and the quaternary ammonium compound.

The biofilm of the present invention may comprise one or more microorganisms selected from the group consisting of bacteria, fungi, algae and archaebacteria. Particularly, the biofilm comprises bacteria, for example, selected from the group consisting of Pseudomonas aeruginosa, Staphylococcus aureus, MRSA, Staphylococcus epidermidis, Salmonella cholerasuis, Clostridium difficile, Escherichia coli and Pseudomonas fluorescens. The biofilm may also comprise two or more bacterial species; in another aspect, it may comprise two or more microorganisms selected from the group consisting of bacteria, fungi, algae and archaebacteria.

In certain aspects, the copper ion of the present invention may comprise a copper salt selected from the group consisting of chlorides, bromides, sulfates, acetates, formates, trichloroacetates, or salts of other organic acids, hydrocarbonates and other solubilizing anions compatible with the quaternary ammonium compound as well as combinations thereof.

In another aspect, the quaternary ammonium compound may be Polycide®, benzalkonium chloride, cetylpyridinium chloride, cetalkonium chloride and myristalkonium chloride, or a chloride or bromide salt of a quaternary ammnonium ion with the following structure:

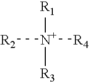

wherein R₁ is an aliphatic hydrocarbon chain (C₈-C₂₅) and R₂, R₃ and R₄ are selected from the chemical groups consisting of methyl, ethyl, n-propyl, or benzyl and combinations thereof, or wherein R₁ and R₂ are hydrocarbons that form part of a heterocyclic ring, R₃ is an aliphatic hydrocarbon chain (C₈-C₂₅), and R₄ is a chemical group consisting of methyl, ethyl, or n-propyl groups, or mixtures thereof.

Exemplary peroxides include, but not are not limited to, Virox™, hydrogen peroxide, mannitol peroxide, sodium peroxide and barium peroxide, or mixtures thereof.

In certain embodiments, there may be provided a composition formulated for inhibiting a biofilm or microbial biofilm-induced corrosion or fouling of a surface or machine, which comprises a copper ion and Polycide® in aqueous solution. In another embodiment, a composition formulated for inhibiting a biofilm or microbial biofilm-induced corrosion or fouling of a surface or machine, which comprises a copper ion and benzalkonium chloride in aqueous solution may be also contemlated. A composition formulated for inhibiting a biofilm or microbial biofilm-induced corrosion or fouling of a surface or machine, which comprises a copper ion and cetylpyridinium chloride in aqueous solution may be comprised in the present invention. Another composition formulated for inhibiting a biofilm or microbial biofilm-induced corrosion or fouling of a surface or machine, which comprises a copper ion and cetalkonium chloride in aqueous solution may also be provided.

In a further embodiment, a composition formulated for inhibiting a biofilm or microbial biofilm-induced corrosion or fouling of a surface or machine, which comprises a copper ion and myristalkonium chloride in aqueous solution may be provided.

It is contemplated that any method or composition described herein can be implemented with respect to any other method or composition described herein.

The use of the word “a” or “an” when used in conjunction with the term “comprising” in the claims and/or the specification may mean “one,” but it is also consistent with the meaning of “one or more” or “at least one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will be apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIGS. 1A-K. An overview of the high-throughput screening method that was used to identify synergistic antimicrobial interactions that kill microbial biofilms. Starting from cryogenic stocks, the desired bacterial strain was streaked out twice on TSA (FIG. 1A), and colonies from these second-subcultures were suspended in growth medium to match a 1.0 McFarland optical standard (FIG. 1B). This standardized suspension served as the inoculum for the CBD when diluted 30-fold in TSB. The inoculated devices were assembled and placed on a gyrorotary shaker for 24 h at 37° C. (FIG. 1C), which facilitated the formation of 96 statistically equivalent biofilms on the peg surfaces. Biofilms were rinsed with 0.9% NaCl (FIG. 1D) and surface-adherent growth was verified by viable cell counting (FIG. 1E). Antimicrobials were set-up in “checkerboard” arrangements in microtiter plates (FIG. 1F), and the rinsed biofilms were inserted into these challenge plates for the desired exposure time (FIG. 1G). Following antimicrobial exposure, biofilms were rinsed and inserted into recovery plates. Biofilms cells were disrupted into the recovery medium using sonication (FIG. 1H), and these recovery plates were incubated for 24 h before reading the OD₆₅₀ of recovered cultures in a microtiter plate reader (FIG. 1I). This allowed the FBC index to be calculated, which was used to identify “lead” synergistic interactions (FIG. 1J). Leads were validated by repeating the testing process (per FIG. 1A-H), but instead of qualitative measurements, biofilm cell survival was quantified by viable cell counting on agar plates (FIG. 1K).

FIGS. 2A-B. An example of “lead” validation using viable cell counting. The high-throughput screening process identified both Cu²⁺ and Virox™ as well as Ag⁺ and Stabrom® as synergistic antimicrobial combinations against P. aeruginosa ATCC 15442 biofilms. To validate these leads, viable cell counts were determined after exposing biofilms to combinations of these agents in 10% TSB/0.9% NaCl for 30 min at room temperature. Synergistic interactions were determined using the lowest FBC index method (as described in Materials and Methods). (FIG. 2A) This process validated Cu²⁺ and Virox™ as an effective antimicrobial combination, as there were concentrations at which the combination of the two compounds eradicated biofilms, whereas either agent used alone did not eliminate residual biofilm cell survival. (FIG. 2B) By contrast, combinations of Ag⁺ and Stabrom® did not kill biofilm cells better than either agent could alone, and therefore, this lead was invalidated by this more rigorous testing process. In these plots, each bar represents the average of three independent replicates.

FIGS. 3A-E. Time-dependent killing of P. aeruginosa ATCC 15442 biofilms by combinations of Cu²+and Polycide®. Viable cell counts were determined after exposing biofilms to combinations of Cu²⁺ and Polycide® in ddH₂O for (FIG. 3A) 10 min or (FIG. 3B) 30 min, or after exposure in 10% TSB/0.9% NaCl for (FIG. 3C) 10 min, (FIG. 3D) 30 min, or (FIG. 3E) 24 h. In these plots, each bar represents the average of three independent replicates. All exposures were carried out at room temperature, except for the 24 h assays, which were conducted at 37° C. In every test scenario, it was possible to discern synergistic killing of biofilms by combinations Cu²⁺ and Polycide® that was greater than the antibacterial efficacy of either agent alone. This synergistic killing was most dramatic for the 24 h time-point, in which combinations of Cu²⁺ and Polycide® were up to 150-times more effective than either agent alone (based on comparisons of MBC_{b} values of single and dual-agent treatments).

FIGS. 4A-D. Combinations of Cu²⁺ with other QACs show synergistic killing of P. aeruginosa ATCC 15442 biofilms. Viable cell counts were determined after exposing biofilms to combinations of Cu²⁺ and (FIG. 4A) benzalkonium chloride, (FIG. 4B) cetylpyridinium chloride, (FIG. 4C) cetalkonium chloride and (FIG. 4D) myristalkonium chloride in 10% TSB/ddH20 for 24 h at 37° C. In these plots, each bar represents the average of two independent replicates. The chemical structures for each of these cations are indicated (n denotes a side chain of variable length, having 8 to 25 carbon atoms).

FIGS. 5A-B. Isothermal titration calorimetry (ITC). Isothermal titration calorimetry (ITC) of (FIG. 5A) 5 mM CuSO₄ into 0.25 mM benzalkonium chloride in water, or (FIG. 5B) 17.8 mM benzalkonium chloride into 1 mM CuSO₄ in phosphate buffer (pH 7.1). In these plots, the squares represent the titration of CuSO₄ into the QAC (or vice versa), whereas the circles represent the titration of CuSO₄ into the appropriate buffer, which is used to account for the heat of dilution. The diamonds and the regression line of best fit represent the addition of CuSO₄ to benzalkonium chloride when corrected for the heat of dilution. In all cases, the slope of the line of best fit did not significantly deviate from zero, indicating that there is no direct interaction between CuSO₄ and benzalkonium chloride in aqueous solutions with or without the addition of 4 mM phosphate buffer (pH 7.1). Each panel is a representative data set from 2 independent replicates.

FIGS. 6A-C. Cell survival and nitrate (NO₃) reduction by anaerobic P. aeruginosa ATCC 15442 cultures grown in the presence of Cu²⁺ and Polycide®, alone and in combination. An aerobic starter culture was grown overnight in TSB and this was diluted 1 in 500 to get a starting cell count of 1×10⁷ CFU/mL for anaerobic cultures. These cells were grown in BHI broth, with and without the addition of 1 mM KNO₃, for 6 h prior to the addition of 1 mM CuSO₄, 25 ppm Polycide , or 1 mM CuSO₄+25 ppm Polycide®. Following an additional 48 h incubation at 37° C., aliquots were removed to determine (FIG. 6A) mean viable cell counts and (FIG. 6B) log-killing. Remaining cells from anaerobic cultures were lysed and fractionated into cytosolic and membrane components. The cytosolic components were assayed for (FIG. 6C) nitrate reductase (NR) activity. In this figure, each bar represents the mean and standard deviation of 3 to 8 independent replicates. NR activity calculations were corrected for baseline shifts in spectrophotometric measurements caused by the presence of oxygen in water, which reacts with reduced methyl viologen over time.

FIGS. 7A-D. Killing of Escherichia coli (FIG. 7A) Pseudomonas fluorescens (FIG. 7B), Salmonella cholerasuis (FIG. 7C) and Staphylococcus aureus (FIG. 7D) biofilms by combinations of Cu²⁺ and Polycide®. Viable cell counts were determined after exposing biofilms to combinations of Cu²⁺ and Polycide® in 10% TSB/0.9% NaCl (or 25% CA-MHB/0.9% NaCl for S. cholerasuis) for 24 h at 37° C. In these plots, each bar represents the average of three independent replicates. These results indicate that Cu²⁺ and Polycide® have broad spectrum antimicrobial activity that, in general, kills biofilms of other Gram-negative and Gram-positive bacteria at concentrations that are much lower than those required to treat P. aeruginosa biofilms. In these plots, each bar represents the average of three independent replicates.

### DESCRIPTION OF THE ILLUSTRATIVE EMBODIMENTS

### I. THE PRESENT INVENTION

The present invention provides for novel methods of inhibiting a biofilm or microbial biofilm-induced corrosion or fouling of a surface or machine with combination of rationally selected agents which particularly reduce microaerobic growth of or kill biofilm organisms synergistically.

By way of example, the inventors have found that Cu²⁺ works synergistically with quaternary ammonium compounds (QACs, specifically benzalkonium chloride, cetalkonium chloride, cetylpyridinium chloride, myristalkonium chloride and Polycide®) to kill Pseudomonas aeruginosa biofilms. In some cases, adding Cu²⁺ to QACs resulted in a 150-fold decrease in the biofilm minimum bactericidal concentration as compared to single-agent treatments. When combined, these agents retained broad spectrum antimicrobial activity that also eradicated biofilms of Escherichia coli, Staphylococcus aureus, Salmonella cholerasuis, and Pseudomonas fluorescens. To investigate the mechanism of action, isothermal titration calorimetry was used to ascertain that Cu²⁺ and QACs do not directly interact in aqueous solutions, suggesting that these agents exert toxicity through different biochemical routes. Additionally, Cu²⁺ and QACs, both alone and in combination, inhibited the activity of nitrate reductases, which are enzymes that are important for normal biofilm growth. Similarly, Cu²⁺ and peroxide were also validated as synergistic antimicrobial combinations with anti-biofilm activity. Therefore, the present invention provides a method of inhibiting biofilms with novel combination of antimicrobial compounds. Certain advantages of the present methods include shortened treatment time, for example, less than four hours, and lowered dose of each agent associated with the synergistic effect of the specific combinations discovered by the inventors.

### II. BIOFILM

A biofilm is a complex aggregation of microorganisms marked by the excretion of a protective and adhesive matrix. Biofilms are also often characterized by surface attachment, structural heterogeneity, genetic diversity, complex community interactions, and an extracellular matrix of polymeric substances. The undesired growth of biofilms on solid surfaces is also termed biofouling. Biofilms consist mainly of water and microbial cells which are embedded in a biopolymer matrix. Biofouling lowers the water quality and increases the frictional resistance in tubes. Further, biofilms increase the pressure differences in membrane processes and can clog filtration membranes, valves, and nozzles.

Single-celled organisms generally exhibit at least two distinct modes of behavior. The first is the familiar free floating, or planktonic, form in which single cells float or swim independently in some liquid medium. The second is an attached state in which cells are closely packed and firmly attached to each other and usually form a solid surface. A change in behavior is triggered by many factors, including quorum sensing, as well as other mechanisms that vary between species. When a cell switches modes, it undergoes a phenotypic shift in behavior in which large suites of genes are up- and down-regulated.

A. Formation

Initial colonization of a surface takes place when an organism present in the bulk water such as Pseudomonas aeruginosa—a common slime-forming bacteria in industrial water systems—adheres to a surface. This change in state from free-swimming/planktonic state to attached/sessile state causes a dramatic transformation in the microorganism. Genes associated with the planktonic state turn off; genes associated with the sessile state turn on. Typically the microorganism loses appendages associated with the free swimming state, such as flagella, and obtains appendages more appropriate for the present situation, such as short, hair-like pili which afford numerous points for attachment. The attachment process further stimulates production of slimy, polysaccharide (starch-like) materials generally termed extracellular polymeric substances (EPS). Given proper conditions, more bacteria attach to the surface. Eventually the surface is covered with a layer of attached bacteria and associated EPS.

If this was all that takes place, biofilms might be relatively easy to control. However, bacteria continue to colonize the surface building up to several and even hundreds of cell layers thick. Recent scientific evidence indicates that this colonization process proceeds with a high degree of order. Cells within the developing microcolony communicate with one another using a signaling mechanism termed quorum sensing. The individual cells constantly produce small amounts of chemical signals. When these signals reach a certain concentration, they modify the behavior of the cells and result, for example, in the creation of water channels. The water channels enable the transport of nutrients into the colony and the removal of waste products from the colony.

Soon other microorganisms find niches within the microcolony suitable for growth. Low oxygen or anaerobic conditions at the substrate/microcolony surface prove inviting for destructive microorganisms such as sulfate-reducing bacteria (SRBs). Protozoa and other amoebae welcome the opportunity to graze on the sessile bacterial community. Legionella pneumophila and/or other pathogenic organisms find suitable niches to reproduce and thrive. The fully developed microcolony thus contains a variety of chemical gradients and consists of a consortia of microorganisms of differing types and metabolic states.

Eventually, conditions within the microcolony may not be ideal for some or all of the microorganisms present. The microorganisms detach, enter the bulk water, and search for other colonization sites. It has been recently been discovered that, as in the case for creation of water channels within the developing biofilm, certain chemical signals govern the detachment process as well.

B. Properties

Bacteria living in a biofilm usually have significantly different properties from free-floating bacteria of the same species, as the dense and protected environment of the film allows them to cooperate and interact in various ways. One benefit of this environment is increased resistance to detergents and antibiotics and reduced susceptibility to biocides, as the dense extracellular matrix and the outer layer of cells protect the interior of the community. In some cases antibiotic resistance can be increased 1000-fold. In other words, once established, biofilms can be persistent and difficult to get rid of. This is due to a number of factors, as discussed below.

Reduced Penetration. Biofilms used to be viewed as offering an impenetrable barrier by virtue of the layer of EPS surrounding the attached organisms. This view has since been modified slightly with the discovery of water channels—in effect a primitive circulatory system—throughout the biofilm. The current view is that although many substances such as chloride ion, for example, enjoy ready access into the interior of the biofilm, reactive substances such as chlorine or other oxidizing biocides can be deactivated via reaction with EPS at the biofilm surface. Secreted enzymes may also degrade the antimicrobial compounds. For example, secreted catalase and beta-lactamase enzymes can degrade peroxides and beta-lactam antibiotics, respectively, before these agents can penetrate to the interior of biofilms. For example, a paper on studies of 7-day biofilms challenged with 5 ppm chlorine indicates that chlorine levels were only 20% that of the bulk water in the biofilm interior. Organisms within the biofilm are thus exposed to reduced amounts of biocide.

Intrinsic Resistance. Biofilm organisms exhibit vastly different characteristic than their planktonic counterparts. For example, a paper published in 1997 shows that even one-day biofilms indicate a much-reduced susceptibility to antibiotics relative to their planktonic counterparts, often requiring a 1000-fold increase in antibiotic dose for complete deactivation of the biofilm

Microbiological Diversity. Biofilms offer many different microniches—oxygen rich areas, oxygen depleted areas, areas of relatively high pH, areas of low pH, etc. These wide-ranging environments lead to diversity in types of organisms and metabolic activity. Cells near the bulk water/biofilm surface, for example, respire and are reported to grow at a greater rate than those within the interior of the biofilm which may be essentially dormant These dormant cells are less susceptible to biocide treatment and can repopulate the biofilm rapidly when conditions are favorable. pH and accumulation of metabolites in biofilms may also antagonize that action of antimicrobials by changing the chemical speciation of the antimicrobial or by undergoing direct chemical reactions with the antimicrobial. In this regard, agents that are effective against planktonic bacteria are chemically inactivated in biofilms of the same bacterial species.

Biofilms are usually found on solid substrates submerged in or exposed to some aqueous solution, although they can form as floating mats on liquid surfaces and also on the surface of leaves, particularly in high humidity climates. Given sufficient resources for growth, a biofilm will quickly grow to be macroscopic. Biofilms can contain many different types of microorganism, e.g., bacteria, archaea, protozoa, fungi and algae; each group performing specialized metabolic functions. However, some organisms will form monospecies films under certain conditions.

C. Examples of Biofilms

Biofilms are ubiquitous. Nearly every species of microorganism, not only bacteria and archaea, have mechanisms by which they can adhere to surfaces and to each other. In various environments, biofilms can develop on a surface or a machine, which can lead to clogging, corrosion or fouling. Biofilms can be found on rocks and pebbles at the bottom of most streams or rivers and often form on the surface of stagnant pools of water. Biofilms on floors and counters can make sanitation difficult in food preparation areas. Biofilms in cooling water systems are known to reduce heat transfer and harbor Legionella bacteria.

Biofilms have been found to be involved in a wide variety of microbial infections in the body, by one estimate 80% of all infections. Infectious processes in which biofilms have been implicated include common problems such as urinary tract infections, catheter infections, middle-ear infections, formation of dental plaque, gingivitis, coating contact lenses, and less common but more lethal processes such as endocarditis, infections in cystic fibrosis, and infections of permanent indwelling devices such as joint prostheses and heart valves.

Biofilms are also present on the teeth of most animals as dental plaque, where they may become responsible for tooth decay and gum disease. Dental plaque is the material that adheres to the teeth and consists of bacterial cells (mainly Streptococcus mutans and Streptococcus sanguis), salivary polymers and bacterial extracellular products. Plaque is a biofilm on the surfaces of the teeth. This accumulation of microorganisms subject the teeth and gingival tissues to high concentrations of bacterial metabolites which results in dental disease.

D. Pseudomonas aeruginosa biofilms

The achievements of medical care in industrialized societies are markedly impaired due to chronic opportunistic infections that have become increasingly apparent in immunocompromised patients and the aging population. Chronic infections remain a major challenge for the medical profession and are of great economic relevance because traditional antibiotic therapy is usually not sufficient to eradicate these infections. One major reason for persistence seems to be the capability of the bacteria to grow within biofilms that protects them from adverse environmental factors.

P. aeruginosa is not only an important opportunistic pathogen and causative agent of emerging nosocomial infections but can also be considered a model organism for the study of diverse bacterial mechanisms that contribute to bacterial persistence. In this context the elucidation of the molecular mechanisms responsible for the switch from planctonic growth to a biofilm phenotype and the role of inter-bacterial communication in persistent disease should provide new insights in P. aeruginosa pathogenicity, contribute to a better clinical management of chronically infected patients and should lead to the identification of new drug targets for the development of alternative anti-infective treatment strategies.

Biofilms of P. aeruginosa are very resilient to antimicrobials and therefore this organism serves as an excellent model for testing novel antibacterial agents. Since P. aeruginosa is generally resistant to many biocides that are lethal to fungal pathogens (ex. Candida spp.), as well as to other Gram-negative and Gram-positive bacteria (McDonnell et al., 1999), agents effective against P. aeruginosa are likely to be effective against biofilms of other organisms as well. Therefore, the inventors systematically tested combinations of rationally selected metals and biocides against P. aeruginosa biofilms, looking for synergistic interactions.

### III. BIOFILMS IN INDUSTRIAL SETTINGS

Biofilms may also adhere to surfaces, such as pipes and filters and may induce corrosion or fouling of a surface or a machine. The surface or machine may be comprised in an oil and gas well drilling system, a heating-cooling system, a water filtration system, a medical device (surgical tool, dental tool), a countertop, a floor, or a food processing tool/equipment. Deleterious biofilms are problematic in industrial settings because they cause fouling and corrosion in systems such as heat exchangers, oil pipelines, and water systems. Biofilms are clearly the direct cause or potentiators for many cooling system problems. Several years ago, the economic impact of biofilms in the U.S. alone was estimated at $60 billion dollars.

Biofilm deposits increase corrosion of metallurgy. The colonization of surfaces by microorganisms and the products associated with microbial metabolic processes create environments that differ greatly from the bulk solution. Low oxygen environments at the biofilm/substrate surface, for example, provide conditions where highly destructive anaerobic organisms such as sulfate reducing bacteria can thrive. This leads to MIC (microbially induced corrosion), a particularly insidious form of corrosion which, according to one published report, can result in localized, pitting corrosion rates 1000-fold higher than that experienced for the rest of the system. In extreme cases, MIC leads to perforations, equipment failure, and expensive reconditioning operations within a short period of time. For example, it has been indicated that in a newly-build university library without an effective microbiological control program sections of the cooling system pipework had to be replaced after just one year of service due to accumulations of sludge, slime, and sulfate-reducing bacteria.

Biofouling may be a biofilm problem which is operationally defined. It applies to biofilms which exceed a given threshold of interference. Biofouling or biological fouling caused by biofilms is the undesirable accumulation of microorganisms on submerged structures, especially ships' hulls. Biofouling is also found in membrane systems, such as membrane bioreactors and reverse osmosis spiral wound membranes. In the same manner it is found as fouling in cooling water cycles of large industrial equipments and power stations. Anti-fouling is the process of removing the accumulation, or preventing its accumulation.

Biofilm inhibitors can be employed to prevent microorganisms from adhering to surfaces which may be porous, soft, hard, semi-soft, semi-hard, regenerating, or non-regenerating. These surfaces include, but are not limited to, polyurethane, metal, alloy, or polymeric surfaces in medical devices, enamel of teeth, and cellular membranes in animals, including, mammals, more specifically, humans. The surfaces may be coated, impregnated or immersed with the biofilm inhibitors prior to use. Alternatively, the surfaces may be treated with biofilm inhibitors to control, reduce, or eradicate the microorganisms adhering to these surfaces.

### IV. MICROORGANISMS

In some embodiments, the methods set forth herein pertain to methods of inhibiting a biofilm or microbial biofilm-induced corrosion or fouling of a surface or a machine. The biofilm may be any of a wide assortment of microorganisms, for example, bacteria, fungi, algae and archaebacteria.

The term “bacteria” encompasses many bacterial strains including gram negative bacteria and gram positive bacteria. Examples of gram negative bacteria include: Acinebacter; Aeromonas; Alcaligenes; Chromobacterium, Citrobacter; Enterobacter; Escherichia; Flavobacterium; Klebsiella; Moraxella; Morganella, Plesiomonas, Proteus, Pseudomonas, Salmonella, Serratia; and Xanthomonas. Examples of gram positive bacteria include: Arthrobacter, Bacillus; Micrococcus, Mycobacteria, Sarcina, Staphylococcus; and Streptococcus. Many of the aforementioned bacterial strains, such as Acinebacter, Aeromonas, Alcaligenes, Arthrobacter, Bacillus, Chromobacterium, Flavobacterium, Micrococcus, Moraxella, Mycobacteria, Plesiomonas, Proteus, Pseudomonas, Sarcina and others, are further referred to as heterotrophic bacteria, as they are extremely hardy and can readily grow in nutrient-poor water. The hydrogenotrophic bacteria preferably comprise one or more species of bacteria selected from the group consisting of Acetobacterium spp., Achromobacter spp., Aeromonas spp., Acinetobacter spp., Aureobacterium spp., Bacillus spp., Comamonas spp., Dehalobacter spp., Dehalospirillum spp., Dehalococcoide spp., Desulfurosarcina spp., Desulfomonile spp., Desulfobacterium spp., Enterobacter spp., Hydrogenobacter spp., Methanosarcina spp., Pseudomonas spp., Shewanella spp., Methanosarcina spp., Micrococcus spp., and Paracoccus spp.

Particularly, the bacteria comprised in the biofilm of the present invention may be selected from the group consisting of Pseudomonas aeruginosa, Staphylococcus aureus, MRSA, Staphylococcus epidermidis, Salmonella cholerasuis, Clostridium difficile, Escherichia coli and Pseudomonas fluorescens.

Organisms particularly relevant to oil field applications include Anoxygenic photoheterotrophs such as Blastochloris sp., denitrifiers, such as Azoarcus sp., Dechloromonas sp., Pseudomonas sp., Thauera sp., Vibrio sp., iron-reducing bacteria, such as Geobacter sp., Shewanella sp., sulfate-reducing bacteria, such as Desulfovibrio sp., Desulfobacterium sp. Desulfobacula sp., methanogens, such as Methanothermobacter sp., Methanobacter sp., Methanobrevibacter sp., Methanococcus sp., Methanosarcina sp. Other microbes include Enterococcus sp., Rhodococcus sp. Marinobacter sp., Acinetobacter sp., Halomonas sp., Sinorhizobium sp., Rhizobium sp., Agrobacterium sp., Comamonas sp., Hydrocarboniphaga sp., Thermoanaerobacter sp., Nitrospira sp., Rhodocyclus sp., Sphinogobacterium sp., Thermotoga sp., Thermodesulfovibrio sp., Fervidobacterium sp., Leplospirillium sp., Thermovenabulum sp., and Thermotogales sp.

### V. ANTIMICROBIAL AGENTS

A. Copper Ion

Copper ion of the present invention can be any copper salt compatible with the quaternary ammonium compound, such as copper sulfate, copper bromide, copper benzoate, copper bicarbonate, copper nitrate, copper nitrite, copper chloride, copper acetate, copper formate, copper trichloroacetate, copper citrate, copper gluconate, copper hydrocarbonates, or salts of organic acids, and other solubilizing anions as well as combinations thereof. The particular copper salt for use as an example in the compositions and method of the present invention is copper sulfate.

Cu²⁺ is an electrophile that likely exerts microbiological toxicity through several biochemical routes simultaneously. This includes autocatalytic formation of ROS via Fenton-type chemistry, oxidation of cellular protein thiols, and the displacement of similar transition metal ions (e.g., Fe³⁺) from the binding sites of other biomolecules (Harrison et al., 2007; Stohs et al., 1995). In all of these cases, Cu²⁺ alters the normal biological function of cellular macromolecules in a detrimental fashion.

B. Quaternary Ammonium Compound

Quaternary ammonium cations, also known as quats, are positively charged polyatomic ions of the structure NR₄⁺ with R being alkyl groups. Unlike the ammonium ion NH₄⁺ itself and primary, secondary, or tertiary ammonium cations, the quaternary ammonium cations are permanently charged, independent of the pH of their solution. Quaternary ammonium cations are synthesized by complete alkylation of ammonia or other amines.

Quaternary ammonium salts or quaternary ammonium compounds (QACs) (called quaternary amines in oilfield parlance) are salts of quaternary ammonium cations with an anion. Quaternary ammonium compound may be Polycide®, benzalkonium chloride, cetylpyridinium chloride, cetalkonium chloride and myristalkonium chloride, or a chloride or bromide salt of a quaternary ammonium cation with the following structure:

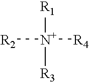

wherein R₁ is an aliphatic hydrocarbon chain (C₈-C₂₅) and R₂, R₃ and R₄ are selected from the chemical groups consisting of methyl, ethyl, n-propyl, or benzyl and combinations thereof; or wherein R₁ and R₂ are hydrocarbons that form part of a heterocyclic ring, R₃ is an aliphatic hydrocarbon chain (C₈-C₂₅), and R₄ is a chemical group consisting of methyl, ethyl, or n-propyl groups, or mixtures thereof.

Bacterial cell membranes are sites of QAC toxicity (McDonnell et al., 1999), and it is thought that these cationic agents generally have a target site at the cytosolic membrane. QACs likely act on the phospholipid components of the membrane, causing membrane deformation, leakage of low molecular weight intracellular material and disruption of the proton motive force (McDonnell et al., 1999). This model of toxicity is supported by evidence that P. aeruginosa may change the composition of its membrane fatty acids in response to QAC exposure (Guerin-Mechin et al., 1999).

C. Peroxide

A peroxide is a compound containing an oxygen-oxygen single bond. Peroxide may be selected from the group consisting of Virox™, hydrogen peroxide, mannitol peroxide, sodium peroxide and barium peroxide, or mixtures thereof.

D. Solvents

Non-limiting examples of solvents for use in the present invention include, water, methanol, ethanol, 1-propanol, 1-butanol, formic acid, acetic acid, formamide, acetone, tetrahydrofuran (THF), methyl ethyl ketone, ethyl acetate, acetonitrile, N,N-dimethylformamide (DMF), diemthyl sulfoxide (DMSO), hexane, benzene, diethyl ether, methylene chloride, carbon tetrachloride, buffering solutions that contain, for example, phosphates or sodium chloride, and organic media, such as tryptic soy broth (TSB) or Mueller-Hinton broth (CA-MHB).

E. Dosage

Copper ion and quaternary ammonium compound may be provided in an amount that induces synergistic killing of organisms in the biofilm, and/or below that which either agent can effectively kill organisms in the biofilm as single agents, and/or that achieves biofilm sterilization. Copper ion and peroxide may be provided in an amount that induces synergistic killing of organisms in the biofilm and/or below that which either agent can effectively kill organisms in the biofilm as single agents. The copper ion may be more than 1 mM, more than 2 mM, more than 4 mM and up to the solubility limit. The quaternary ammonium compound may be more than 25 ppm, more specifically, 50 ppm, 100 ppm, 200 ppm, 400 ppm, 800 ppm, 1600 ppm, or higher than 1600 ppm, or any concentration in between the foregoing.

By definition, synergy occurs when two or more discrete agents act together to create an effect greater than the sum of the effects of the individual agents. In principle, synergy allows for a reduction in the quantity of agents used in combination, and yet, might still allow for greater antimicrobial activity. Other advantages to using multiple, compatible agents in combination include lowering the probability that resistance will emerge and increasing the spectrum of microbicidal activity. This latter advantage may be used in tailoring combinations of agents for use against bacterial biofilms, as adherent microbial populations produce phenotypic variants that reduce biofilm susceptibility to single agent treatments (Boles et al., 2004; Drenkard et al., 2002; Harrison el al., 2007; Spoering et al., 2001). Particularly, a combination is considered synergistic if there is a ≧1-log₁₀ decreases in the mean CFU/peg between the metal-biocide combination and the most active comparable single agent treatment following 10 or 30 min exposure, and/or ≧2-log₁₀ decreases at 24 h exposure. It may be also required that the combination produce a ≧2-log₁₀ decrease in the mean CFU/peg relative to the starting biofilm cell count (TABLE 1) and that one agent be present at a concentration that did not affect the number of surviving cells relative to the appropriately treated growth control.

TABLE 1
Bacterial Strains Used in Examples

| | | Mean biofilm | | |
|---|---|---|---|---|
| | | cell density^{a} | | |
| Strain | Relevant characteristics | (CFU/peg − 1) | n | Source |
| Escherichia coli | Isolated from a | 5.7 ± 0.4 | 60 | This |
| MBEC03 | slaughterhouse | | | invention |
| Pseudomonas | Standard strain for biocide | 6.8 ± 0.6 | 297 | ATCC |
| aeruginosa ATCC | susceptibility testing (AOAC | | | |
| 15442 | guidelines)^{c} | | | |
| Pseudomonas | Standard strain for antibiotic | 6.7 ± 0.2 | 8 | Ceri et al., |
| aeruginosa ATCC | susceptibility testing (CLSI | | | 1999 |
| 27853 | guidelines)^{d} | | | |
| Pseudomonas | Environmental organism | 5.7 ± 0.5 | 12 | Workentine |
| fluorescens ATCC | implicated in food spoilage | | | et al., |
| 13552 | | | | 2007 |
| Salmonella | Standard strain for biocide | 4.7 ± 0.4 | 64 | ATCC |
| cholerasuis ATCC | susceptibility testing (AOAC | | | |
| 10708 | guidelines)^{c} | | | |
| Staphylococcus | Standard strain for biocide | 5.6 ± 0.4 | 60 | ATCC |
| aureus ATCC 6538 | susceptibility testing (AOAC | | | |
| | guidelines)^{c} | | | |

^{a}Starting cell density measurements were based on the mean and standard deviation of the pooled, log-transformed data for the indicated number of replicates (n)
^{b}AOAC is the Association of Official Analytical Chemists
^{c}CLSI is the Clinical Laboratory Standards Institute (formerly the National Committee for Clinical Laboratory Standards)

In certain embodiments, copper ion and quaternary ammonium compounds (QACs) or peroxide may be provided in combinations that induce synergistic killing of organisms in the biofilm. Particularly, copper ion from 0.0625-32 mM may be combined with QACs from 0.75-800 ppm. Alternatively, synergistic combinations of copper ion and QAC could have relative weight ratios ranging from 1:10 to 50:1. Those of copper ion and peroxide could have relative weight ratios ranging from 1:3 to 1:60.

Cu²⁺ and QACs have been used in combination for more than 15 years in the forest industry. Ammoniacal copper quaternary (ACQ) is a combination of copper oxide (CuO) with the QAC didecyldimethylammonium chloride (DDAC) that has been used as a fungicidal and insecticidal wood preservative since the early 1990's. ACQ is considered environmentally friendly and it is estimated that in 1996, 454,000 kg of DDAC was released into the environment in British Columbia, Canada for this purpose alone (Juergensen et al., 2000).

However, biofilms are a different environment. Microorganisms present in a biofilm have an increased resistance to desiccation, grazing, and antimicrobial agents. Synergistic interactions in multispecies biofilms have been suggested to enhance biofilm formation and increase resistance to antimicrobial agents (Burmølle et al., 2006). Accordingly, the synergy between Cu²⁺ and QACs for biofilm disinfection discovered in the present invention is novel and may be an explanation for the effectiveness of ACQ as a wood preservative. Furthermore, this indicates that ACQ as well as other Cu-QAC combinations might be successfully applied to treat biofilms in a wide range of additional environments where surface-associated microbial growth is unwanted or damaging.

### VI. EXAMPLES

The following examples are included to further illustrate various aspects of the invention. It should be appreciated by those of skill in the art that the techniques disclosed in the examples that follow represent techniques and/or compositions discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Materials and Methods

Strains and growth media. All of the microbial strains used in this study are summarized in TABLE 1 and all were stored at −70° C. in Microbank™ vials (ProLab Diagnostics, Toronto, Canada) according to the manufacturer's directions. These organisms were cultured on tryptic soy agar (TSA, EMD Chemicals Inc., Gibbstown, USA) and incubated at 30° C for 24 to 48 h. Biofilms of all of the organisms used in the invention were cultivated in tryptic soy broth (TSB, EMD Chemicals Inc.) and all serial dilutions were performed using 0.9% NaCl. Susceptibility testing was performed in 10% TSB diluted with either 0.9% saline (NaCl) or double-distilled water (ddH₂O), as indicated throughout this disclosure. As the exception, Salmonella cholerasuis ATCC 10708 was cultivated in cation-adjusted Mueller-Hinton broth (CA-MHB, EMD Chemicals, Inc.) and tested in 25% CA-MHB that had been diluted with 0.9% NaCl. For microaerobic conditions, P. aeruginosa was sealed tightly in 1.0 L bottles, which had been completely filled with brain-heart infusion (BHI) broth (EMD Chemicals Inc.), and was grown at 37° C., with or without 1 mM KNO₃, as indicated throughout this disclosure.

Stock solutions of metals and biocides. Sodium selenite (Na₂SeO₃, Sigma Chemical Company, St. Louis, USA), silver nitrate (AgNO₃, Sigma), cupric sulfate (CuSO₄.5H₂O, Fischer Scientific, Ottawa, ON, Canada), zinc sulfate (ZnSO₄.7H₂O, Fischer Scientific), aluminium sulfate (Al₂(SO₄)₃.18H₂O, Fischer Scientific), and “powder 1” (a proprietary silver oxysalt provided by Innovotech Inc., Edmonton, AB, Canada) were diluted in sterile ddH₂O to make stock solutions at twice the maximum concentration used for susceptibility testing. Additional, serial two-fold dilutions of each of these agents were prepared as required in sterile polypropylene tubes using ddH₂O.

Polycide® (Pharmax Limited, Toronto, ON, Canada), Virox™ (Virox Technologies Incorporated, Oakville, ON, Canada) and Stabrom® 909 (Albemarle Corporation, Richmond, Va., USA) were diluted in ddH₂O to four times the working concentration that was recommended by the manufacturer. Isopropyl alcohol (Sigma) was made up to a 70% v/v solution in ddH₂O. Benzalkonium chloride (alkyldimethylbenzyl ammonium chloride, Sigma), cetalkonium chloride (cetyldimethylbenzyl ammonium chloride, FeF Chemicals, Denmark), cetylpyridinium chloride (cetyldimethylpyridyl ammonium chloride, FeF Chemicals) and myristalkonium chloride (tetradecyldimethylbenzyl ammonium chloride, FeF Chemicals) were made up to stock concentrations of 10,000 ppm in ddH₂O. Solutions of QACs were incubated at 37° C to facilitate dissolution.

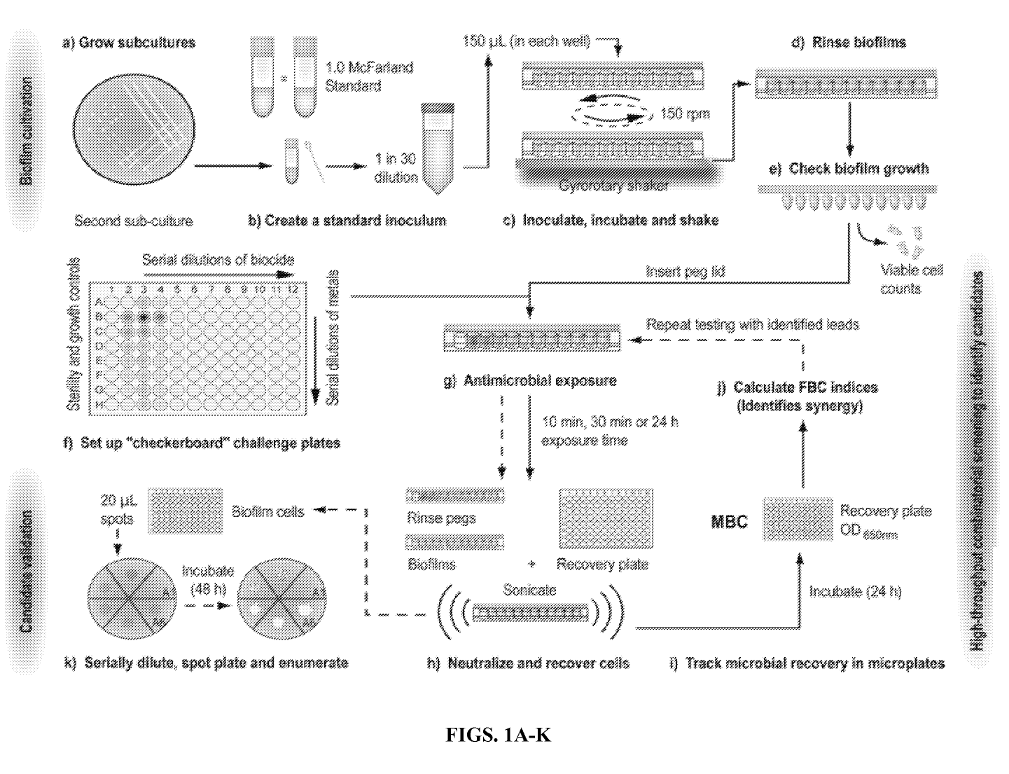

Biofilm cultivation. Biofilms were grown in the Calgary Biofilm Device (CBD, commercially available as the MBEC™ Physiology and Genetics assay, Innovotech Inc., Edmonton, AB, Canada), as originally described (Ceri et al., 1999). An overview of this biofilm cultivation technique (as well the high-throughput screening process described below) is illustrated in FIGS. 1A-K. The CBDs consist of a polystyrene lid, with 96 downwards protruding pegs, that fit into standard 96-well microtiter plates. Starting from cryogenic stocks, the desired bacterial strain was streaked out twice on TSA, and an inoculum was prepared by suspending colonies from the second agar subculture in 0.9% NaCl to match a 1.0 McFarland Standard. This standard inoculum was diluted 30-fold in growth medium to get a starting viable cell count of roughly 1.0×10⁷ cfu/mL. 150 μL of this inoculum was transferred into each well of a 96-well microtiter plate and the sterile peg lid of the CBD was inserted into this plate. The inoculated device was then placed on a gyrorotary shaker at 125 rpm for 24 h incubation at 37° C. and 95% relative humidity.

Following this initial period of incubation, biofilms were rinsed once with 0.9% saline (by placing the lid in microtiter plate containing 200 μL of 0.9% NaCl in each well) to remove loosely adherent planktonic cells. Biofilm formation was evaluated by breaking off four pegs from each device after it had been rinsed. Biofilms were disrupted from pegs and into 200 μL of 0.9% NaCl using an ultrasonic cleaner on the ‘high’ setting for a period of 5 min (Aquasonic model 250 HT, VWR Scientific, Mississauga, Canada) as previously described (Ceri et al., 1999). The disrupted biofilms were serially diluted and plated onto agar for viable cell counting. The pooled mean starting viable cell counts for biofilms are summarized in TABLE 1, above.

In an additional set of quality control assays, it was ascertained that the strains used in this study formed equivalent biofilms on the pegs of the CBD. To do this, the inventors disrupted biofilms from the lid of the CBD into a microtiter plate containing 200 μL of 0.9% NaCl in each well, then serially diluted the recovered cells and plated these onto TSA for viable cell counting. These agar plates were incubated for 24 h 37° C. and then the colonies were enumerated. Viable cell counts were grouped by row of the CBD and these values were compared using one-way analysis of variance (ANOVA) as previously described (Ceri et al., 1999). In all cases, biofilms cultivated under the conditions reported here formed statistically equivalent biofilms between the rows of the CBD (p>0.05).

High-throughput susceptibility testing of microbial biofilms. “Checkerboard” arrangements of biocides and toxic metal species were made in 96-well microtiter plates as previously described (Moody, 1995). When prepared, each checkerboard microtiter plate had 7 sterility controls, 2 growth controls, 10 different concentrations of biocides alone, 7 different concentrations of toxic metal species alone, and each metal and biocide at 70 different combinations of concentrations (TABLE 2). The use of these checkerboard plates in the process of biofilm susceptibility testing is briefly described here (FIGS. 1F-J).

TABLE 2
“Checkerboard” configuration of the antimicrobial challenge plate
used to determine antimicrobial interactions during high-throughput screening.^{a}

| | 1 | 2 | 3 | 4 | 5 | 6 | 7 | 8 | 9 | 10 | 11 | 12 |
|---|---|---|---|---|---|---|---|---|---|---|---|---|
| A | Growth | Growth | A 2 x | A x | A x · 2⁻¹ | A x · 2⁻² | A x · 2⁻³ | A x · 2⁻⁴ | A x · 2⁻⁵ | A x · 2⁻⁶ | A x · 2⁻⁷ | A x · 2⁻⁸ |
| | Control | Control | | | | | | | | | | |
| B | Sterility | M y | A 2 x | A x | A x · 2⁻¹ | A x · 2⁻² | A x · 2⁻³ | A x · 2⁻⁴ | A x · 2⁻⁵ | A x · 2⁻⁶ | A x · 2⁻⁷ | A x · 2⁻⁸ |
| | Control | | M y | M y | M y | M y | M y | M y | M y | M y | M y | M y |
| C | Sterility | M y · 2⁻¹ | A 2 x | A x | A x · 2−1 | A x · 2⁻² | A x · 2⁻³ | A x · 2−4 | A x · 2⁻⁵ | A x · 2⁻⁶ | A x · 2⁻⁷ | A x · 2⁻⁸ |
| | Control | | M y · 2⁻¹ | M y · 2⁻¹ | M y · 2⁻¹ | M y · 2⁻¹ | M y · 2⁻¹ | M y · 2⁻¹ | M y · 2⁻¹ | M y · 2⁻¹ | M y · 2⁻¹ | M y · 2⁻¹ |
| D | Sterility | M y · 2⁻² | A 2 x | A x | A x · 2−1 | A x · 2⁻² | A x · 2⁻³ | A x · 2⁻⁴ | A x · 2⁻⁵ | A x · 2⁻⁶ | A x · 2⁻⁷ | A x · 2⁻⁸ |
| | Control | | M y · 2⁻² | M y · 2⁻² | M y · 2⁻² | M y · 2⁻² | M y · 2⁻² | M y · 2⁻² | M y · 2⁻² | M y · 2⁻² | M y · 2⁻² | M y · 2⁻² |
| E | Sample | M y · 2⁻³ | A 2 x | A x | A x · 2⁻¹ | A x · 2−2 | A x · 2⁻³ | A x · 2⁻⁴ | A x · 2⁻⁵ | A x · 2⁻⁶ | A x · 2⁻⁷ | A x · 2⁻⁸ |
| | Peg | | M y · 2⁻³ | M y · 2⁻³ | M y · 2⁻³ | M y · 2⁻³ | M y · 2⁻³ | M y · 2⁻³ | M y · 2⁻³ | M y · 2⁻³ | M y · 2⁻³ | M y · 2⁻³ |
| F | Sample | M y · 2⁻⁴ | A 2 x | A x | A x · 2⁻¹ | A x · 2⁻² | A x · 2⁻³ | A x · 2⁻⁴ | A x · 2⁻⁵ | A x · 2⁻⁶ | A x · 2⁻⁷ | A x · 2⁻⁸ |
| | Peg | | M y · 2⁻⁴ | M y · 2⁻⁴ | M y · 2⁻⁴ | M y · 2⁻⁴ | M y · 2⁻⁴ | M y · 2⁻⁴ | M y · 2⁻⁴ | M y · 2⁻⁴ | M y · 2⁻⁴ | M y · 2⁻⁴ |
| G | Sample | M y · 2⁻⁵ | A 2 x | A x | A x · 2⁻¹ | A x · 2⁻² | A x · 2−3 | A x · 2⁻⁴ | A x · 2⁻⁵ | A x · 2⁻⁶ | A x · 2⁻⁷ | A x · 2⁻⁸ |
| | Peg | | M y · 2⁻⁵ | M y · 2⁻⁵ | M y · 2⁻⁵ | M y · 2⁻⁵ | M y · 2⁻⁵ | M y · 2⁻⁵ | M y · 2⁻⁵ | M y · 2⁻⁵ | M y · 2⁻⁵ | M y · 2⁻⁵ |
| H | Sample | M y · 2⁻⁶ | A 2 x | A x | A x · 2⁻¹ | A x · 2⁻² | A x · 2−3 | A x · 2⁻⁴ | A x · 2⁻⁵ | A x · 2⁻⁶ | A x · 2⁻⁷ | A x · 2⁻⁸ |
| | Peg | | M y · 2⁻⁶ | M y · 2⁻⁶ | M y · 2⁻⁶ | M y · 2⁻⁶ | M y · 2⁻⁶ | M y · 2⁻⁶ | M y · 2⁻⁶ | M y · 2⁻⁶ | M y · 2⁻⁶ | M y · 2⁻⁶ |

^{a}This is for testing antimicrobial A (concentrations in ppm) with metal M (concentrations are in mM). “x” denotes the working concentration of the antimicrobial A as recommended by the manufacturer, and “y” denotes a starting metal concentration that is less than the minimum bactericidal concentration for the biofilm (MBC_{b}).

Biofilms that had been grown on lids of the CBD were inserted into the checkerboard challenge plates after the biofilms had been rinsed (as described above). Following antimicrobial exposure, biofilms were rinsed again (by placing the lid in microtiter plate containing 200 μL of 0.9% NaCl in each well) and then placed in a microtiter “recovery” plate that contained 200 μL of neutralizing medium in each well (TSB supplemented with 1% Tween-20, 2.0 g/L reduced glutathione, 1.0 g/L L-histidine, and 1.0 g/L L-cysteine). These steps were carried out to minimize the effects of biocide and metal carry-over. Bacterial cells were recovered from biofilms by disrupting the biofilms into the recovery medium using an ultrasonic cleaner (as described above). These plates were then incubated for 24 h at 37° C.

Minimum bactericidal concentrations for the biofilm (MBC_{b}) were determined by reading the optical density at 650 nm (OD₆₅₀) of the recovery plates using a Thermomax® microtiter plate reader with Softmax Pro® data analysis software (Molecular Devices, Sunnyvale, Calif. USA). For the purpose of high-throughput screening, the inventors arbitrarily defined an effective MBCb endpoint as an OD₆₅₀≦0.300. By contrast, growth controls incubated under identical conditions typically produced an OD₆₅₀≈0.9 to 1.5.

To validate the “leads” identified from high-throughput screening (see the section below for the criteria used to evaluate this data), mean viable cell counts were determined for biofilms following exposure to metals and/or biocides (FIG. 1K). This was done by serially diluting (ten-fold) 20 μL aliquots from the wells of the recovery plates (prepared as described above) in 0.9% saline and by plating these diluted cultures onto TSA. To allow recovery of all viable bacteria surviving antimicrobial exposure, 48 h of incubation at 37° C. were allowed before growth on these agar plates was scored.

Criteria for evaluating the anti-biofilm activity of combination antimicrobials. “Lead” synergistic interactions were identified using rules that were modified from those suggested by the American Society for Microbiology for the testing of planktonic cells (Moody, 1995). Synergy was defined mathematically by calculating the sum (Σ) of the fraction bactericidal concentration (FBC) values (termed the FBC index) for each combination of antimicrobial agents:
FBC of agent A=(MBC_{b} of agent A in combination)/(MBC_{b} of agent A alone) FBC of agent B=(MBC_{b} of agent B in combination)/(MBC_{b} of agent B alone) ΣFBC=FBC of agent A+FBC of agent B

For the purpose of evaluating antimicrobial interactions, the inventors used the lowest FBC index method as previously described (Bonapace et al., 2002). Here, the FBC index was based on the lowest ΣFBC that was calculated for all of the wells along the kill/non-kill interface, using the median MBC_{b} values for single agent treatments as the reference points (see TABLE 3). Taking into account the error associated with biofilm susceptibility testing using the CBD, which generally produces endpoints over a 16-fold range (compared to a 4-fold range for planktonic cell susceptibility testing), survival data from the high-throughput susceptibility assays were grouped as follows: 1) if ΣFBC≦0.125, then the antimicrobials exhibited synergy, 2) if 0.125≦ΣFBC<16, then indifference had occurred, or 3) if ΣFBC≧16, then the antimicrobials exhibited antagonism.

TABLE 3
Susceptibility of P. aeruginosa ATCC 15442 biofilms to single agent treatments
as determined by high-throughput screening (using the Calgary Biofilm Device)^{a}

| Metal ion or | Biofilm minimum bactericidal concentration (MBCb)^{b} | | | | | |
|---|---|---|---|---|---|---|
| biocide^{c} | 5 min | | 30 min | | 24 h | |
| Ag⁺(mM) | >19 | | >19 | | >19 | |
| Cu²⁺(mM) | >32 | | >32 | | 32 | (16 to 32) |
| Al³⁺(mM) | >76 | | >76 | (38 to >76) | 76 | (76 to >76) |
| SeO₃²⁻(mM) | >16 | | >16 | | >16 | |
| Zn² + (mM) | >31 | | >31 | | >31 | |
| Powder 1 (ppm) | >2500 | (2500 to >2500) | >2500 | (1250 to >2500) | nd | |
| Polycide ® (ppm) | >3200 | (50 to >3200) | 1800 | (100 to >3200) | 400 | (50 to 800) |
| Stabrom ® (ppm) | 250 | (31 to >500) | 250 | (16 to >500) | 94 | (63 to >1600) |
| Isopropyl Alcohol (%) | 0.50 | (0.25 to 0.50) | 0.50 | (0.25 to 0.50) | 0.50 | (0.25 to >0.50) |
| Virox ™ (ppm) | 313 | (156 to 5000) | 313 | (156 to 2500) | 625 | (313 to 2500) |

^{a}Note that these assays were performed using a high-throughput screening method that judges killing qualitatively. Incomplete killing of microbial populations may still occur with short exposure times, but this will not be detected by the high-throughput method employed here.
^{b}Susceptibility testing was performed in double distilled water for exposure times of 5 and 30 min, whereas 10% tryptic soy broth/0.9% NaCl was used for 24 h exposures.
^{c}Compositions of biocides: Polycide ® - benzalkonium chloride and cetyldimethylethylammonium chloride; Stabrom ® - BrCl (a halide); Virox ™ - acclerated hydrogen peroxide. nd denotes results that were not-determined.

For the purpose of evaluating time-kill data based on mean viable cell counts, which was used to validate leads identified by high-throughput screening, the inventors looked for ≧1-log₁₀ decreases in the mean CFU/peg between the metal-biocide combination and the most active comparable single agent treatment following 10 or 30 min exposure, and ≧2-log₁₀ decreases at 24 h exposure. It was also required that the combination produce a ≧2-log₁₀ decrease in the mean CFU/peg relative to the starting biofilm cell count (TABLE 1) and that one agent be present at a concentration that did not affect the number of surviving cells relative to the appropriately treated growth control.

Confocal-laser scanning microscopy (CLSM). Pegs were broken from the lid of the CBD using needle nose pliers. Cell viability staining of P. aeruginosa ATCC 27853 biofilms using the Live/Dead® BacLight™ Kit (Molecular Probes, Burlington, ON, Canada) was carried out according to the method as previously described (Harrison et al., 2007). Here, biofilms exposed to metals and/or biocides were rinsed twice with 0.9% saline and then stained with Syto-9 and propidium iodide at 30° C. for 30 min. Fluorescently labeled biofilms were placed in two drops of 0.9% saline on the surface of a glass coverslip. These pegs were examined using a Leica DM IRE2 spectral confocal and multiphoton microscope with a Leica TCS SP2 acoustic optical beam splitter (AOBS) (Leica Microsystems, Richmond Hill, ON, Canada) as previously described (Harrison el al., 2007). To eliminate artefacts associated with single wavelength excitation, Live/Dead® stained samples were sequentially scanned, frame-by-frame, first at 488 nm and then at 543 nm. Fluorescence emission was then sequentially collected in the green and red regions of the spectrum. A 63× water immersion objective was used in all imaging experiments. Image capture and two-dimensional reconstruction of z-stacks was performed using Leica Confocal Software (Leica Microsystems).

Isothermal titration calorimetry (ITC). All measurements were made on a Microcal VP-ITC instrument (Microcal LLC, Northampton, Mass., USA). Briefly, a time course of injections of CuSO₄ to benzalkonium chloride (and vice versa) was made in a reaction cell maintained at a constant temperature. These experiments were performed in both double distilled water and in 4 mM phosphate buffer (pH 7.1). The VP-ITC instrument measures the heat generated or absorbed by any reaction or interaction that occurs, which is later corrected for heats of dilution. A binding isotherm was fitted to the data, expressed in terms of heat change per mole of CuSO₄ (or benzalkonium chloride) plotted against the molar ratio of CuSO₄ to benzalkonium chloride. In principle, it is possible to calculate, from the binding isotherm, values for the reaction stoichiometry, association constants (Ka), the change in enthalpies (AH°), and change in entropies (ΔS) for any reaction that has occurred. If no reaction has occurred, then the corrected binding isotherms will be straight lines with a slope that approximates zero.

Protein fractionation and nitrate reduction assays. Planktonic cells grown under microaerobic conditions were collected by centrifugation (3000×g for 20 min), washed once with phosphate buffered saline (PBS, pH 7.2), and collected by centrifugation again. Cell pellets were suspended in PBS with 2 mg/mL lysozyme (Sigma) and incubated on ice for 30 min. The enzyme treated cells were then disrupted with a Microsan Ultrasonic Cell Disruptor (Misonix Inc., Farmingdale, N.Y., USA) using 5×5 s bursts at a 5 W power setting. Cell debris was removed by centrifugation (3000×g for 30 min), and the supernatant was additionally fractionated into membrane and cytosolic components by a second centrifugation at 125,000×g for 90 min. Nitrate reductase activity was determined spectrophotometrically at 575 nm for cytoplasmic fractions, using methyl viologen as an electron donor, as previously described (Jones et al., 1977; Magalon et al., 1998).

Statistical tests and data analysis. ANOVA was performed using MINITAB® Release 14 (Minitab Inc., State College, Pa., USA) to analyze log₁₀-transformed raw data. Alternate hypotheses were tested at the 95% level of confidence. Mean and standard deviation calculations were performed using Microsoft® Excel 2003 (Microsoft Corporation, Redmond, Wash., USA), and this data was imported into SigmaPlot 10.0 (Systat Software Inc., San Jose, Calif., USA) for three-dimensional graphical representation.

Preparation of “checkerboard” challenge plates. Starting from the third well in each row of a microtiter plate, serial two-fold dilutions of biocides (taken from previously prepared working solutions) were made at twice the desired concentrations along the rows of wells to give an initial volume of 100 μL per well. To the first and second well of each row, 200 and 100 μL of the appropriate growth medium were added, respectively. Next, 100 μL of the desired stock metal solutions were added to each well of rows B to H, from wells 2-12, with each row receiving a different concentration of toxic metal species, so as to set-up a serial two-fold dilution gradient in a direction perpendicular to the gradient used for the biocide. Lastly, row A of the microtiter plate received 100 μL of the appropriate growth medium from wells 2-12. Sterility and growth controls were positioned in a regular fashion throughout the first wells of each row by breaking off pegs from the CBD as desired. In the end, each microtiter plate well had a final volume of 200 μL and this was sufficient to completely immerse the CBD biofilms.

### Example 2

### High-throughput Susceptibility Testing

The inventors conducted a high-throughput screen (FIGS. 1A-K) to identify combinations of antimicrobial agents that might possess anti-biofilm activity against P. aeruginosa ATCC 15442 (a strain used for the regulatory testing of hard-surface disinfectants). Here, checkerboard arrangements of antimicrobials in 96-well microtiter plates were used to examine 4 classes of biocides (QACs, halides, peroxides and alcohols, at 10 different concentrations each) alone or in combination with 6 different metal cations and oxyanions (Cu²⁺, Ag⁺, Al³⁺, SeO₃²⁻, Zn²⁺ as well as a proprietary silver oxysalt, at 7 different concentrations each). Additionally, the inventors examined three different exposure durations (10 min, 30 min and 24 h). When completed, this high-throughput screening process evaluated a total of 5307 unique combinations of agents, concentrations and exposure times. For simplicity, these initial results were categorized by metal-biocide combination and then evaluated using the criteria defined in the Example 1 (see TABLE 4). This approach identified six “lead” combinations of antimicrobials: 1) Cu²⁺ and ViroX™ (“accelerated” hydrogen peroxide), 2) Ag⁺ and Stabrom® (a halide disinfectant), 3) Cu²⁺ and Polycide® (a mixture of QACs), 4) Al³⁺ and ViroX™, 5) SeO₃²⁻ and Stabrom®, and 6) SeO₃²⁻ and Virox™.

TABLE 4
Lowest FBC indices for combinations of biocides and metals tested
against P. aeruginosa ATCC 15442 biofilms during high-throughput screening to
determine synergy (using the Calgary Biofilm Device)^{a}

| | | | Biocide^{c} | | | |
|---|---|---|---|---|---|---|
| | Exposure | | | Stabrom ® | 70% | |
| Metal | time^{b} | | Polycide ® | 909 | w/v isopropanol | Virox ™ |
| Ag⁺ | 5 | min | nd | 0.02 | 1.0 | 4.0 |
| | 30 | min | 0.36 | 0.04 | nd | 0.53 |
| | 24 | h | 1.0 | nd | 0.15 | 0.14 |
| Cu²⁺ | 5 | min | 1.25 | nd | 2.0 | 2.0 |
| | 30 | min | 0.03 | nd | 0.72 | 0.51 |
| | 24 | h | 0.06 | 0.67 | 1.0 | 0.08 |
| Al³⁺ | 5 | min | 0.5 | nd | 0.52 | nd |
| | 30 | min | 0.24 | nd | 0.52 | 0.52 |
| | 24 | h | nd | 1.7 | 2.0 | 0.08 |
| SeO₃²⁻ | 5 | min | 2.0 | nd | 1.0 | 2.0 |
| | 30 | min | 0.13 | 0.05 | 0.53 | 0.53 |
| | 24 | h | 0.53 | 1.3 | 0.51 | 0.03 |
| Zn²⁺ | 5 | min | nd | 1.1 | 1.1 | 1.0 |
| | 30 | min | nd | 0.52 | 2 | 0.52 |
| | 24 | h | 0.625 | 1.25 | 0.16 | 0.14 |
| Powder 1 | 5 | min | 2.0 | 3.0 | 0.38 | 1.1 |
| (a proprietary | 30 | min | 1.0 | 2.1 | 0.41 | 0.31 |
| silver | 24 | h | nd | nd | nd | nd |
| oxysalt) | | | | | | |

^{a}Note that these assays were performed using a high-throughput screening method that judges killing qualitatively. Incomplete killing of microbial populations may still occur synergistically with short exposure times, but this will not be detected by the high-throughput method employed here.
^{b}Susceptibility testing was performed in double distilled water for exposure times of 5 and 30 min, whereas 10% tryptic soy broth/0.9% NaCl was used for 24 h exposures.
^{c}Compositions of biocides: Polycide ® - benzalkonium chloride and cetyldimethylethylammonium chloride; Stabrom ® - BrCl (a halide); Virox ™ - accelerated hydrogen peroxide. nd denotes results that were not-determined.
bold denotes a synergistic interaction as defined by the criteria outlined in the Materials and Methods.

From this initial data set, combinations of Al³⁺ or SeO₃²⁻ with biocides were not examined any further (this decision was made based on the high in vitro concentrations at which the synergy was observed as well as due to the formation of metal precipitates in the culture media). Next, false positives were eliminated from the remaining data sets by counting the number of viable cells in biofilms that had been exposed (for 30 min) to different concentrations of these agents alone and in combination.

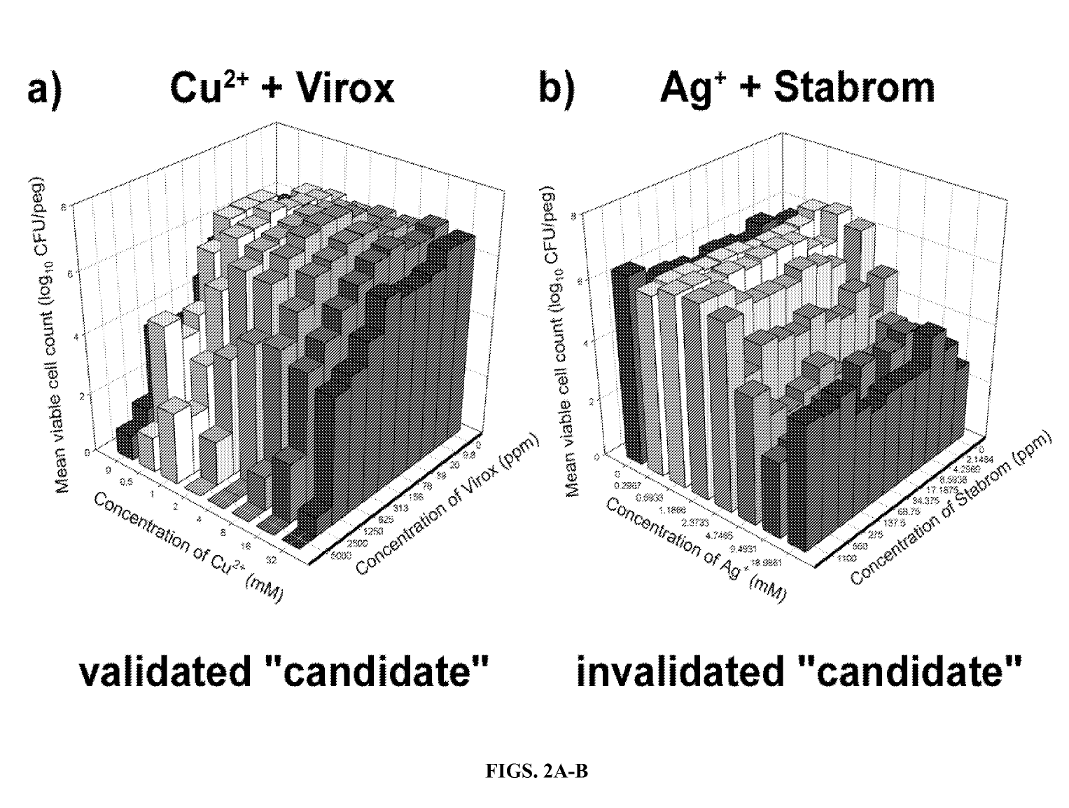

Here, a combination was considered synergistic if, at 30 min exposure, there was a ≧1-log₁₀ decrease in the mean CFU/peg between the combination and the most active comparable single agent treatment (see Example 1 for additional criteria). This process eliminated Ag⁺ and Stabrom® (FIG. 2B) as a synergistic antimicrobial combination, but validated both Cu²⁺ and Virox™ (FIG. 2A) and Cu²⁺ and Polycide® as synergistic antimicrobial combinations with anti-biofilm activity. In this case, P. aeruginosa ATCC 15442 biofilms were killed synergistically by Cu²⁺ and Virox™ with as little as 30 min exposure (FIG. 2A).

Although there is at least one study that has previously looked at combinations of Cu²⁺ with QACs as antimicrobials (Vievskii et al., 1994), there is no examination of these compounds together as anti-biofilm agents. This latter finding caught the inventors' attention immediately since previous work has shown that in contrast to planktonic bacterial cells, biofilms are generally highly resistant and/or tolerant to both QACs (Gilbert et al., 2001; Sandt et al., 2007; Takeo et al., 1994) and copper cations (Davies et al., 2007; Harrison et al., 2005; Teitzel et al., 2006; Teitzel et al., 2003). It is worth noting that QACs might be advantageous compounds to use in antimicrobial formulations as they may function as cleansers or deodorizers (McDonnell et al., 1999), and when used effectively, generally exhibit broad spectrum antimicrobial activity that may be residually active on surfaces.

### Example 3

### Time-and Concentration Dependent Killing of P. aeruginosa Biofilms by Cu²⁺ and Polycide®

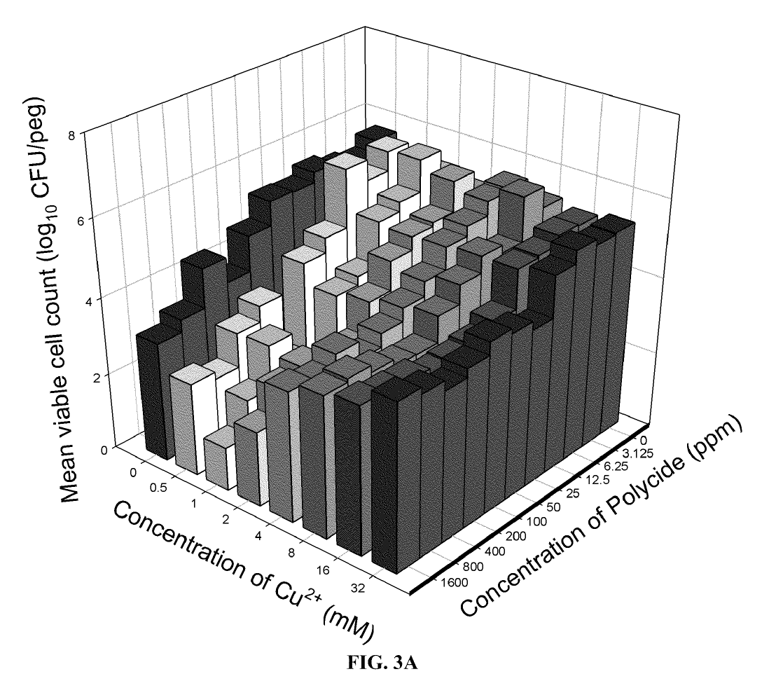

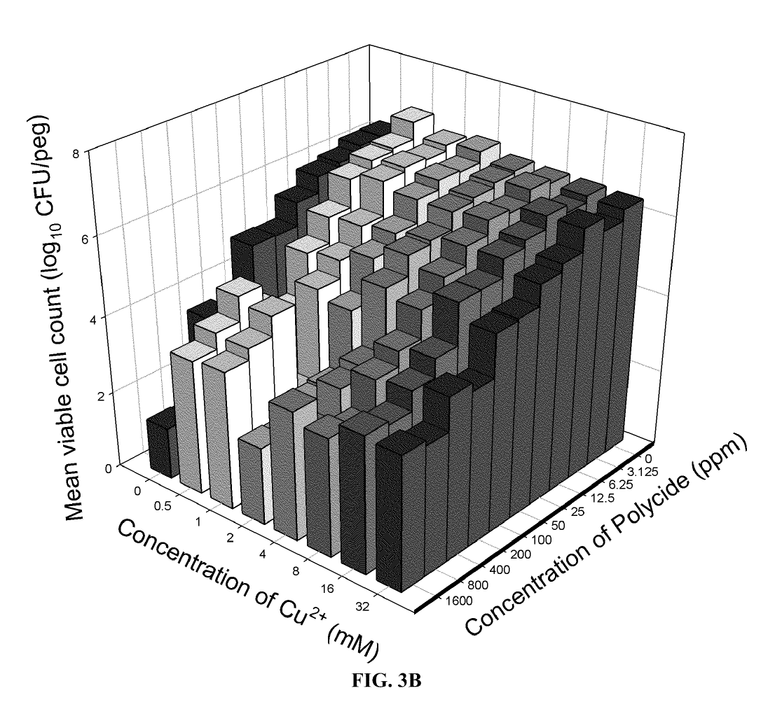

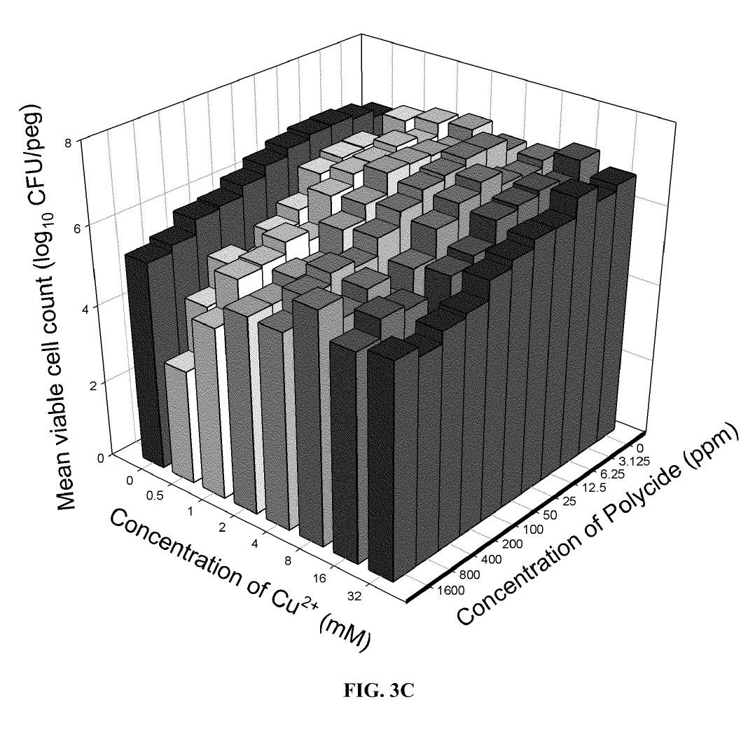

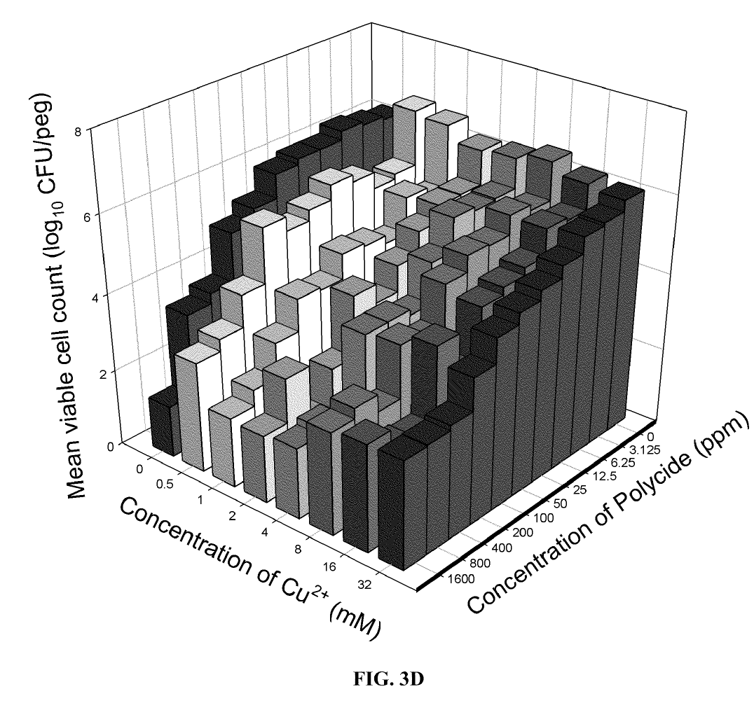

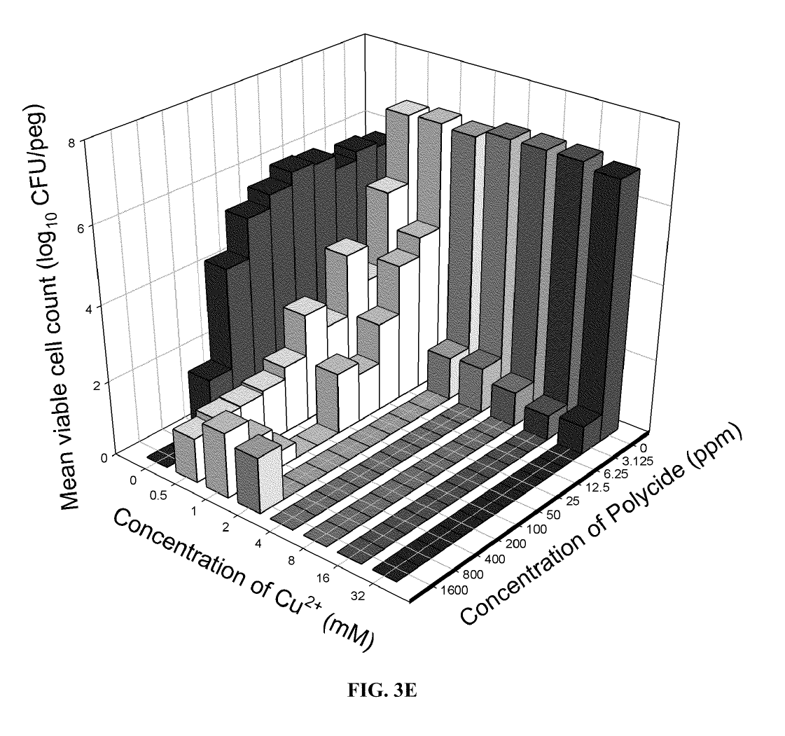

The guidelines set by the Association of Official Analytical Chemists (AOAC) suggest that to demonstrate antibacterial efficacy of novel compounds for use as disinfectants, susceptibility testing should be conducted using double distilled water (ddH₂O) to dissolve the antimicrobials. The AOAC also suggests that cell survival should be evaluated after 10 min and 30 min exposure. The inventors performed these assays and these data are presented in FIG. 3A and FIG. 3B, respectively. In addition to these assays, the inventors also examined biofilm cell survival in the presence of rich medium (the contents of which may decrease the efficacy of some metal cations and QACs via unwanted chemical reactions). In this case, the inventors dissolved the antimicrobials in 10% TSB-0.9% NaCl and evaluated the number of surviving cells in biofilms after 10 min, 30 min and 24 h exposure (FIG. 3C, FIG. 3D and FIG. 3E, respectively). At many of the combination concentrations tested—both in ddH₂O and in organic media—Cu and Polycide® killed 10- to 100-times more biofilm cells than either antimicrobial alone. Furthermore, at 24 h exposure, combinations of Cu with Polycide® were able to reduce the number of surviving biofilm cells below the threshold of detection in vitro, indicating that these compounds might be sterilizing the biofilm at concentrations that were at least 150-fold lower than the sterilizing concentrations of either agent alone (FIG. 3E). These assays rigorously validated Cu²⁺ and Polycide® as a synergistic combination of antibacterials with high anti-biofilm activity against P. aeruginosa ATCC 15442.

### Example 4

### Cu²⁺ and Polycide® have Broad Spectrum Antimicrobial Activity

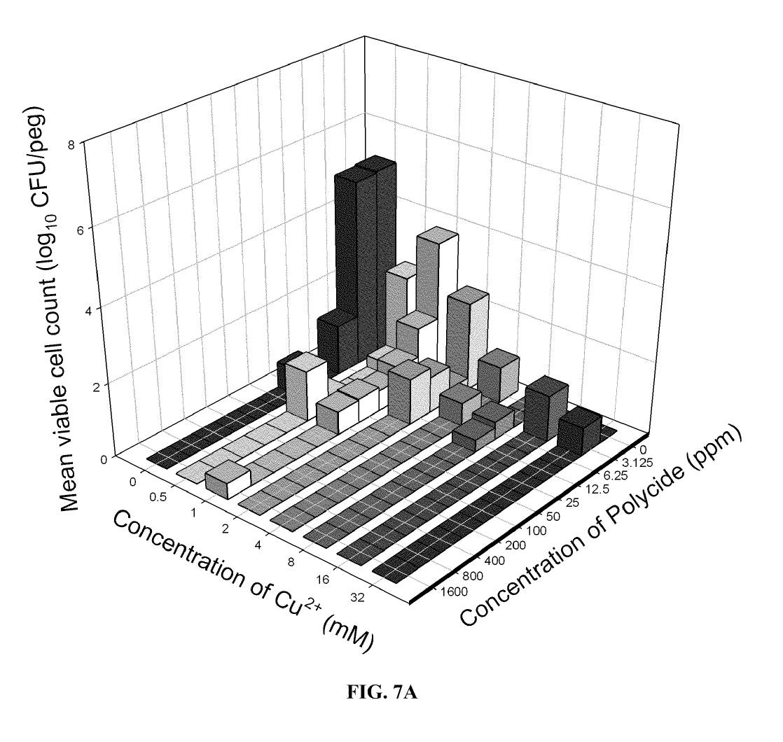

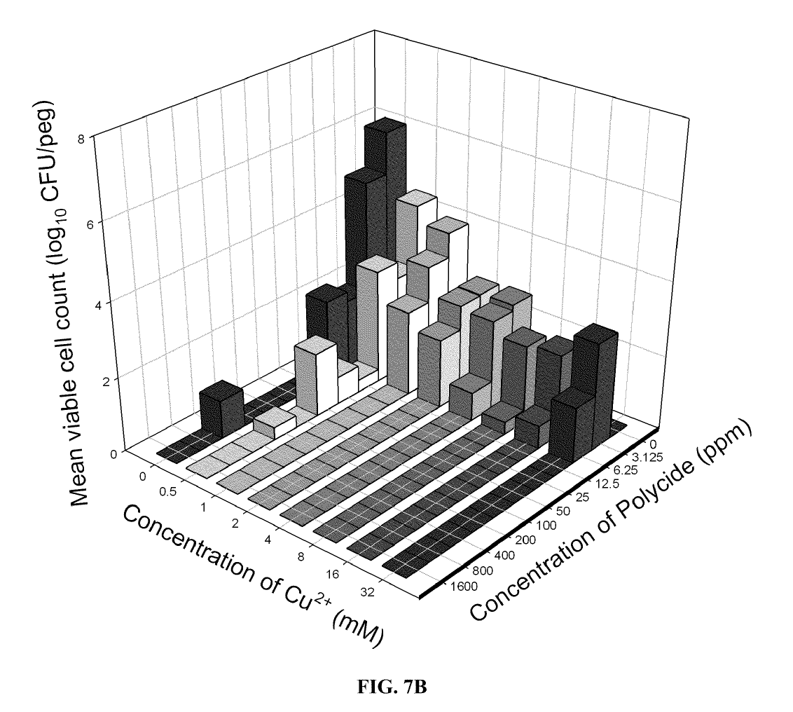

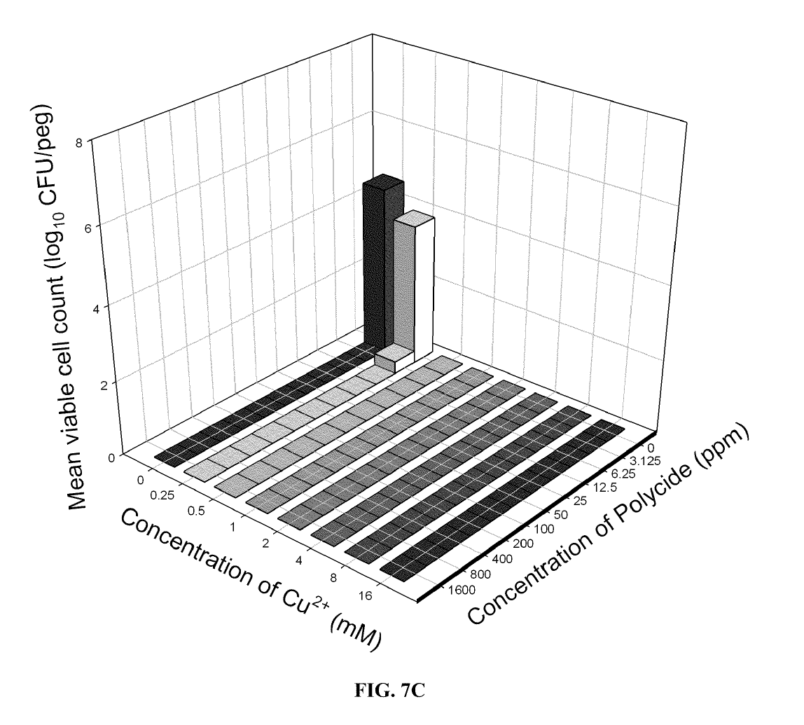

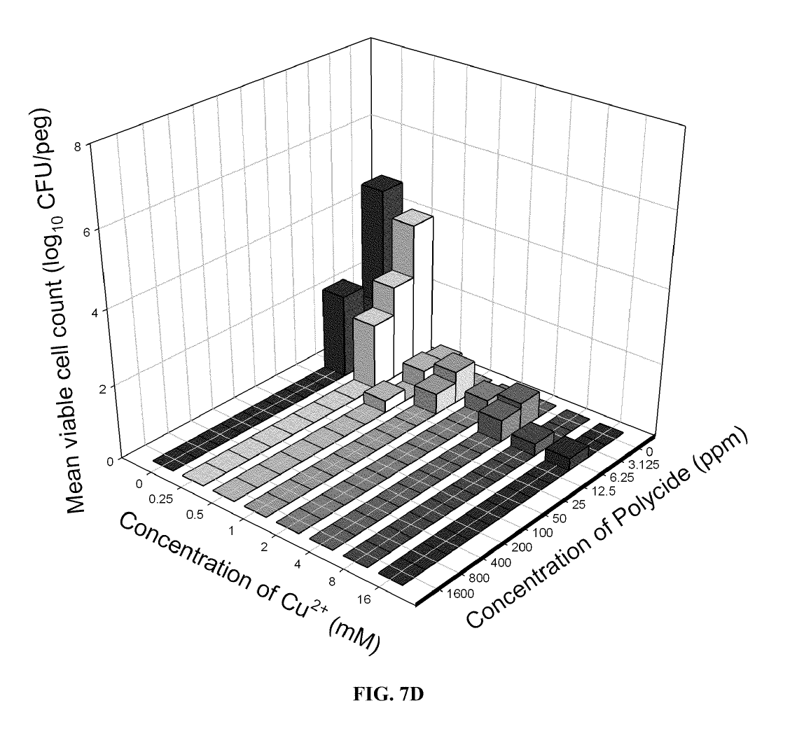

In addition to P. aeruginosa ATCC 15442, the AOAC suggests a standard set of two additional strains to assess antibacterial efficacy of novel disinfectants: Staphylococcus aureus ATCC 6538 and Salmonella cholerasuis ATCC 10708 (see FIGS. 8A-D). In addition to these two strains, the inventors examined Escherichia coli MBEC03, a food borne strain that the inventors isolated from a slaughterhouse, and Pseudomonas fluorescens ATCC 15325, a microbial species implicated in food spoilage (see FIGS. 7A-D). The results of these additional biofilm susceptibility assays indicate that combinations of Cu²⁺ and Polycide® have a broad spectrum of antibacterial activity; furthermore, these agents may eradicate biofilms formed by other microbes at concentrations that are much lower than those required to treat P. aeruginosa ATCC 15442 biofilms.

### Example 5

### CLSM of Bacterial Cell Survival in Biofilms Exposed to Cu²⁺ and Polycide® both alone and in Combination

Up to this point, the inventors have assessed the antimicrobial action of Cu²⁺ and Polycide® using viable cell counting; however, there is an alternate method of assessing biofilm cell survival: CLSM in conjunction with Live/Dead® staining. There are now scattered reports in the literature that Cu²⁺ may induce a viable-but-nonculturable (VBNC) state in some bacteria (Alexander et al., 1999; Grey et al., 2001; Ordax et al., 2006). Live/Dead® staining may be used to discriminate the VBNC phenomenon from cell death. The Live/Dead stain uses the nucleic acid intercalators Syto-9 (which passes through intact membranes and fluoresces green in viable, or living, cells) and the counterstain propidium iodide (which is expelled from viable cells but fluoresces red when bound to DNA and RNA in dead cells). In other words, using this technique it is possible to obtain images of biofilms where viable, or living, cells appear green and dead cells appear red (Harrison et al., 2007). Here, the inventors used this qualitative approach to examine P. aerugionsa ATCC 27853 biofilms that were treated with Cu²⁺ and Polycide®, both alone and in combination. The inventors has previously identified that this particular strain of P. aeruginosa forms complex three-dimensional structures when grown on the peg surfaces of the CBD.

In contrast to growth controls, which were chiefly comprised of living bacterial cells, treatment with 8 mM Cu²⁺ killed a significant portion of the bacterial population. Similarly, 200 ppm Polycide® killed a large portion of the P. aeruginosa biofilms, with many surviving cells localized to interior regions of the surface-adherent community. By contrast, the combination of 8 mM Cu²⁺ with 200 ppm Polycide® killed the vast majority of the biofilm bacteria, with few survivors at the surface or in the interior regions of larger microcolonies. Cumulatively, these results corroborate the conclusion, based on viable cell counts, that Cu²⁺ and Polycide are bactericidal, and that these agents have anti-biofilm activity against P. aerugionsa. The next logical step was to examine the active ingredients of Polycide® (benzalkonium chloride and cetyldimethylethylammonium bromide), as well as other QACs, in combination with Cu²⁺ as novel antibacterial formulations.

### Example 6

### Synergistic Killing of P. aeruginosa Biofilms by Cu²⁺ in combination with Structurally different QACS

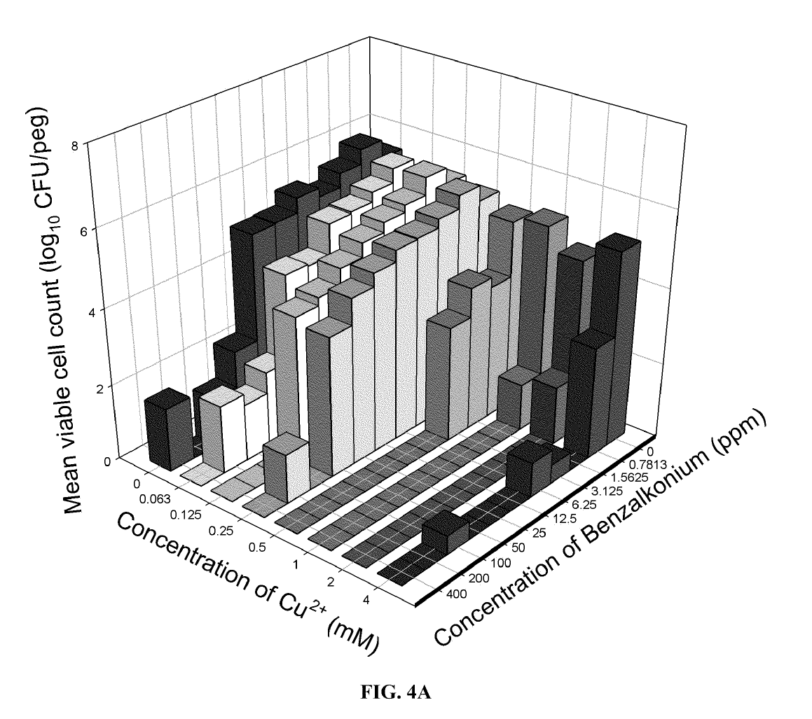

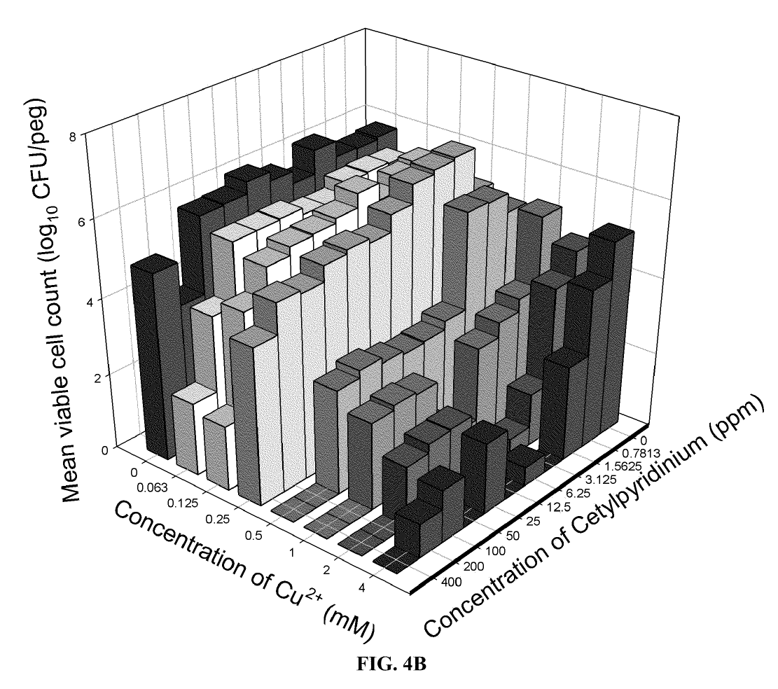

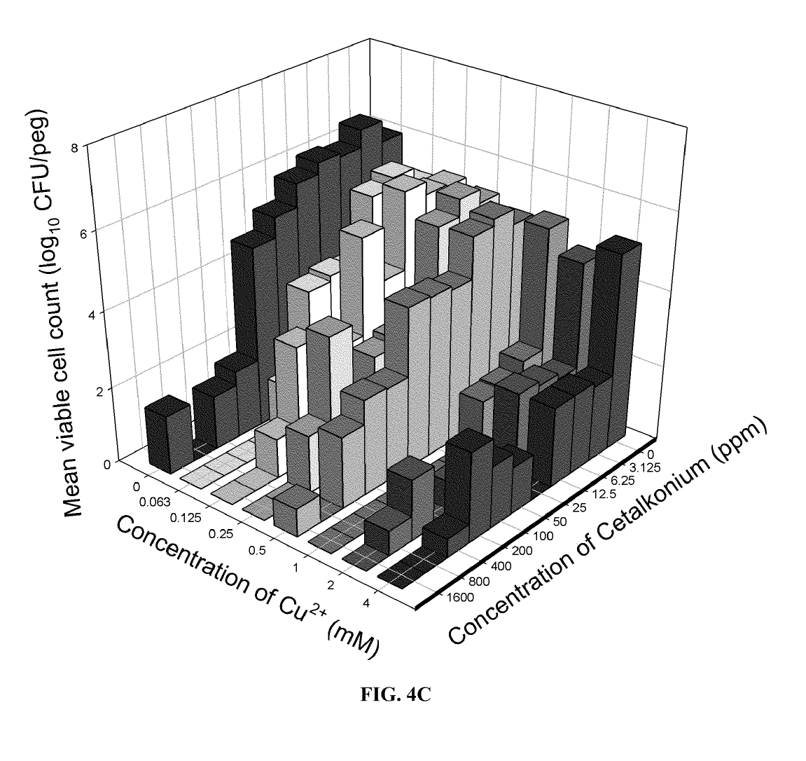

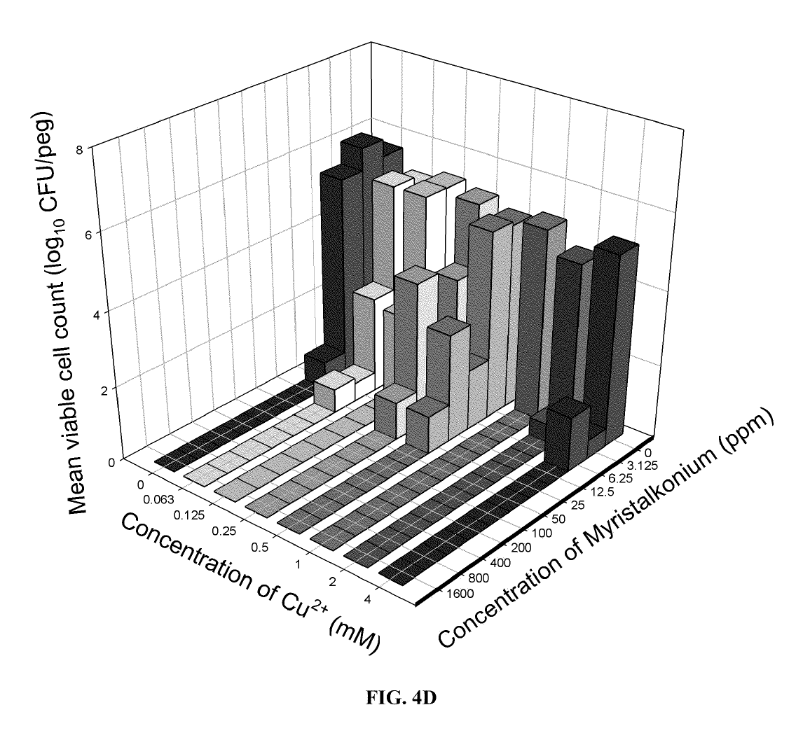

The inventors tested four additional QACs for possible synergistic interactions with Cu²⁺: benzalkonium chloride, cetylpyridinium chloride, cetalkonium chloride and myristalkonium chloride (FIGS. 4A-C). In all cases, it was possible to identify concentrations at which the combination of QAC with Cu²⁺ was more effective at killing P. aeruginosa ATCC 15442 biofilms than the most effective single agent used alone. This was particularly true of Cu²⁺ in combination with either benzalkonium chloride (FIG. 4A) or cetalkonium chloride (FIG. 4C). These results clearly indicate that Cu²⁺ in combination with other (structurally different) QACs can function synergistically to kill P. aerugionsa ATCC 15442 biofilms.

### Example 7

### Cu²⁺ and Benzalkonium Chloride do not directly Interact in Aqueous Solutions

The inventors then tried to determine if Cu and QACs might interact in solution, which might explain why and how these agents are toxic to bacteria. QACs have a wide range of industrial applications, including some use as phase-transfer catalysts to partition heavy metals from water into organic solvents. Here, the inventors hypothesized that this might involve the formation of a complex between the QAC and metal ion. Coordination of Cu²⁺ by QACs might also account for the synergistic activity against biofilms, as complex formation might affect rates of diffusion into the biofilm matrix or partitioning into biomembranes. Therefore, the inventors tested whether benzalkonium chloride, a QAC that exhibited synergistic killing of biofilms in conjunction with Cu²⁺ (either alone or as a component of Polycide®), might bind to this heavy metal in aqueous solutions. To do this, the inventors used isothermal titration calorimetry, a sensitive biophysical technique used to measure the heat released or absorbed during the binding of a ligand to another molecule.

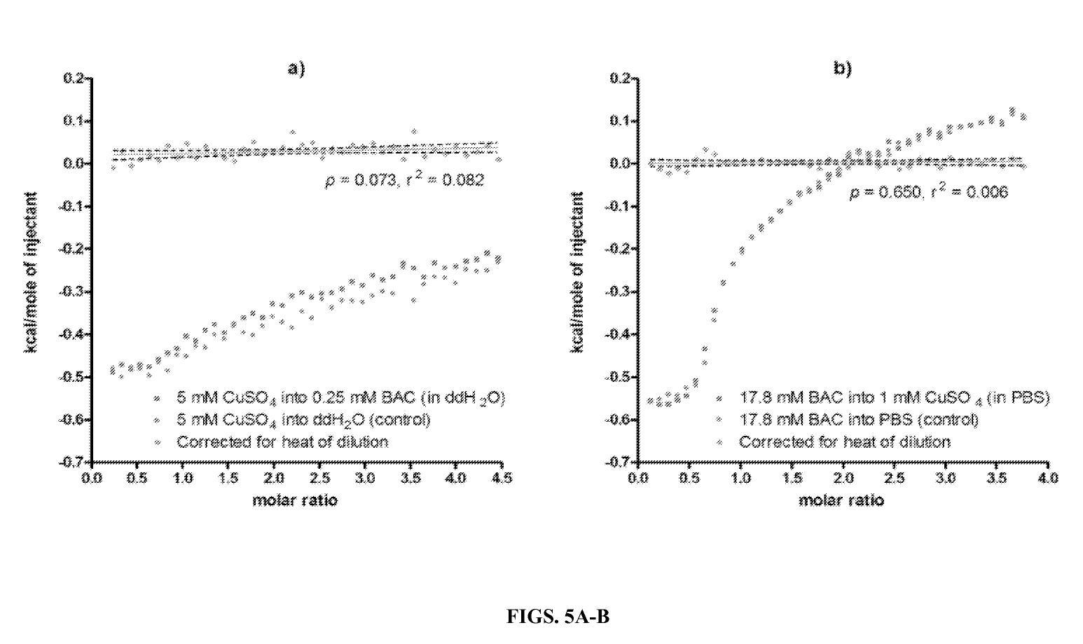

Contrary to the hypothesis, the inventors observed no evidence for binding of Cu²⁺ to benzalkonium chloride when the titration was carried out in ddH₂O (FIG. 5A). They also looked for binding of Cu²⁺ to benzalkonium chloride in 4 mM phosphate buffer (pH 7.1), as it is possible, under aqueous conditions, for PO₄³⁻ to coordinate Cu²⁺ to ammonium groups (R—NH₃⁺) similar to synthetic metallo-receptors (Tobey et al., 2003). Again, there was no evidence that, together, these compounds formed a tertiary complex (FIG. 5B). The inventors concluded from these data that, under the tested aqueous conditions, Cu²⁺ and benzalkonium chloride neither formed complexes nor underwent chemical reactions, as the latter possibility would have also resulted in the release or absorption of heat. This suggests that Cu²⁺ and QACs are likely toxic to bacterial biofilms through independent but complementary biochemical mechanisms (i.e., these compounds are truly synergistic in terms of biological toxicity).

### Example 8

### Effects of Cu²⁺ and QACS on Microaerobic growth and P. aeruginosa Nitrate Reduction

Membrane bound enzymes may be targets for Cu²⁺ and QAC toxicity and it has been suggested that these agents might also inhibit the activity of periplasmic or membrane-bound nitrate reductases (NRs) in P. aeruginosa (Vievskii et al., 1994). Here, this was investigated as a mechanism of toxicity, as microaerobic growth that involves both oxygen (Alvarez-Ortega et al., 2007) and nitrate reduction is part of normal P. aeruginosa biofilm development (Alvarez-Ortega et al., 2007; Palmer et al., 2007; Palmer et al., 2007; Yoon et al., 2002).

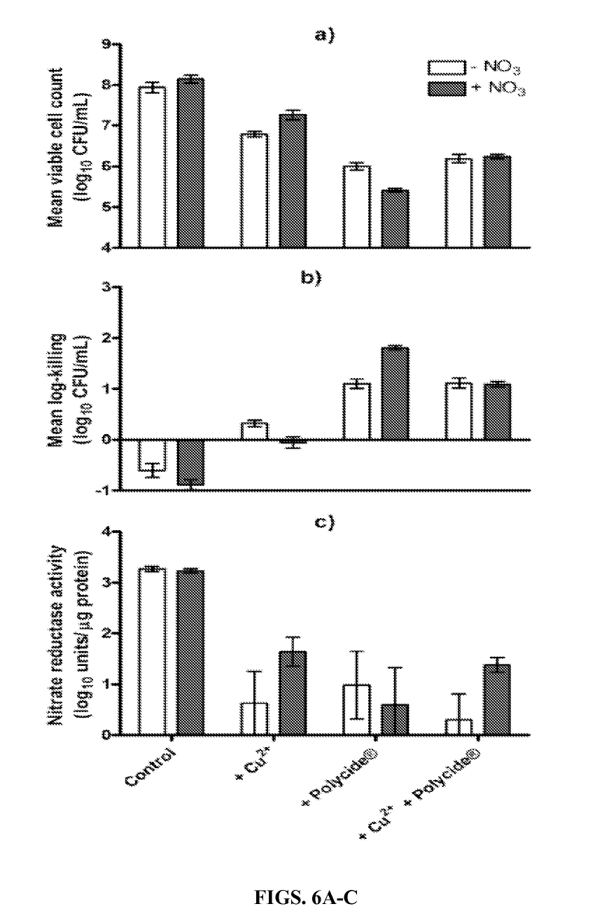

At the lowest concentrations exhibiting synergistic killing of biofilms, CuSO₄ (1 mM) and Polycide® (25 ppm) were bacteriostatic and bactericidal to microaerobic cultures of P. aeruginosa ATCC 15442, respectively (FIG. 6A and FIG. 6B). Interestingly, cell lysates from P. aeruginosa grown in the presence of either of these compounds also had a significantly reduced capacity for nitrate reduction (FIG. 6C). Under these microaerobic conditions, a combination of CuSO₄ (1 mM) plus Polycide® (25 ppm) was bactericidal and showed approximately the same level of killing as Polycide® used alone (FIG. 6A and FIG. 6B), as well as comparably reduced levels of NR activity. It is also worth noting that the addition of 1 mM KNO₃ to the microaerobic growth medium (BHI broth, which contains an undefined amount of nitrates) partially alleviated toxicity and NR inhibition by CuSO₄. Nonetheless, these results show that both Cu²⁺ and QACs, when used alone and in combination, inhibit nitrate reduction activities by P. aeruginosa.

All of the compositions and/or methods disclosed and claimed herein can be made and executed without undue experimentation in light of the present disclosure. While the compositions and methods of this invention have been described in terms of particular embodiments, it will be apparent to those of skill in the art that variations may be applied to the compositions and/or methods in the steps or in the sequence of steps of the method described herein without departing from the concept, spirit and scope of the invention. More specifically, it will be apparent that certain agents that are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### VII. REFERENCES

The following references, to the extent that they provide exemplary procedural or other details supplementary to those set forth herein, are specifically incorporated herein by reference:
Alexander et al., Applied and Environmental Microbiology 65:3754-3756, 1999
Alvarez-Ortega et al., Molecular Microbiology 65:153-165, 2007.
Bjarnsholt et al., APMIS 115:921-928, 2007.
Boles et al., Proceedings of the National Academy of Sciences of the United States of America 101:16630-16635, 2004.
Bonapace et al., Diagnostic Microbiology and Infectious Disease 44:363-366, 2002.
Burmølle et al., Appl Environ Microbiol. June;72(6):3916-23, 2006
Ceri et al., Journal of Clinical Microbiology 37:1771-1776, 1999.
Davies et al., FEMS Microbiology Ecology 59:32-46, 2007.
Drenkard et al., Nature 416:740-743, 2002.
Gilbert et al., Journal of Applied Microbiology 91:248-254, 2001.
Grey et al., Applied and Environmental Microbiology 67:5325-5327, 2001.
Guerin-Mechin et al., Journal of Applied Microbiology 87:735-742, 1999.
Hall-Stoodley et al., Nature Reviews Microbiology 2:95-108, 2004.
Harrison et al., Microbiology 151:3181-3195, 2005.
Harrison et al., Environmental Microbiology 6:1220-1227, 2004.
Harrison et al., Nature Reviews Microbiology 5:928-938, 2007.
Harrison et al., Applied and Environmental Microbiology 73:4940-4949, 2007.
Harrison et al., Environmental Microbiology 7:981-994, 2005.
Jones et al., Biochemistry Journal 164:199-211, 1977.
Juergensen et al., Environmental Toxicology 15:174-200, 2000.
Kaneko et al., Journal of Clinical Investigation 117:877-888, 2007.
Lewis, Nature Reviews Microbiology 5:48-56. 2007.
Magalon et al., Journal of Biological Chemistry 273:10851-10856, 1998.
McDonnell et al., Clinical Microbiology Reviews 12:147-179, 1999.
Moody, In H. D. Isenberg and J. Hindler (ed.), Clinical microbiology procedures handbook, vol. 1. American Society for Microbiology Press, Washington, D.C. 1995.
Ordax et al., Applied and Environmental Microbiology 72:3482-3488, 2006.
Palmer et al., Journal of Bacteriology 189:8079-8087, 2007.
Palmer et al., Journal of Bacteriology 189:4449-4455, 2007.
Sandt et al., Journal of Antimicrobial Chemotherapy 60:1281-1287, 2007.
Spoering et al., Journal of Bacteriology 183:6746-6751, 2001.
Stohs et al., Free Radical Biology and Medicine 18:321-36, 1995.
Takeo et al., Microbios 79:19-26, 1994.
Teitzel el al., Journal of Bacteriology 188:7242-7256, 2006.
Teitzel el al., Applied and Environmental Microbiology 69:2313-2320, 2003.
Tobey et al., Journal of the American Chemical Society 125:14807-14815, 2003.
Vievskii et al., A. N. Mikrobiologicheskii Zhurnal 56:16-20, 1994
Wood et al., Journal of Applied Microbiology 84:1092-1098, 1998.
Workentine et al., Environmental Microbiology 10:238-250, 2007.
Yoon et al., Developmental Cell 3:593-603, 2002.

What is claimed:

1. A method of inhibiting a biofilm comprising contacting said biofilm with copper and a quaternary ammonium compound, wherein inhibiting occurs in less than about 4 hours.

2. The method of claim 1, wherein inhibiting comprises reducing microaerobic growth of organisms in said biofilm (bacteriostatic), or killing organisms in said biofilm (bactericidal).

3. The method of claim 1, wherein said biofilm comprises one or more microorganisms selected from the group consisting of bacteria, fungi, algae and archaebacteria.

4. The method of claim 3, wherein said biofilm comprises bacteria.

5. The method of claim 4, wherein said bacteria is selected from the group consisting of Pseudomonas aeruginosa, Staphylococcus aureus, MRSA, Staphylococcus epidermidis, Salmonella cholerasuis, Clostridium difficile, Escherichia coli and Pseudomonas fluorescens.

6. The method of claim 4, wherein said biofilm comprises two or more bacterial species.

7. The method of claim 3, wherein said biofilm comprises two or more microorganisms selected from the group consisting of bacteria, fungi, algae and archaebacteria.

8. The method of claim 1, wherein copper ion comprises a copper salt selected from the group consisting of chlorides, bromides, sulfates, acetates, formates, trichloroacetates, as well as combinations thereof.

9. The method of claim 1, wherein said quaternary ammonium compound is selected from the group consisting of Polycide®, benzalkonium chloride, cetylpyridinium chloride, cetalkonium chloride and myristalkonium chloride, or a chloride or bromide salt of a quaternary ammonium cation with the following structure: 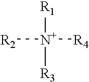
wherein R₁ is an aliphatic hydrocarbon chain (C₈-C₂₅) and R₂, R₃ and R₄ are selected from the chemical groups consisting of methyl, ethyl, n-propyl, or benzyl and combinations thereof; or wherein R₁ and R₂ are hydrocarbons that form part of a heterocyclic ring, R₃ is an aliphatic hydrocarbon chain (C₈-C₂₅), and R₄ is a chemical group consisting of methyl, ethyl, or n-propyl groups, or mixtures thereof.

10. The method of claim 1, wherein (a) copper ion and said quaternary ammonium compound are provided in an amount that induces synergistic killing of organisms in said biofilm; and/or (b) copper ion and said quaternary ammonium compound are provided in amount below that which either agent can effectively kill organisms in said biofilm as single agents; and/or (c) copper ion and said quaternary ammonium compound are provided in amount that achieves biofilm sterilization.

11. A method of inhibiting microbial biofilm-induced corrosion or fouling of a surface or machine comprising treating a surface biofilm or machine biofilm with copper ion and a quaternary ammonium compound.

12. The method of claim 11, wherein said surface or machine is comprised in an oil and gas well drilling system, a heating-cooling system, a water filtration system, a medical device (surgical tool, dental tool), a countertop, a floor, or a food processing tool/equipment.

13. The method of claim 11, wherein said biofilm comprises one or more microorganisms selected from the group consisting of bacteria, fungi, algae and archaebacteria.

14. The method of claim 13, wherein said biofilm comprises bacteria.

15. The method of claim 14, wherein said bacteria is selected from the group consisting of Pseudomonas aeruginosa, Staphylococcus aureus, MRSA, Staphylococcus epidermidis, Salmonella cholerasuis, Clostridium difficile, Escherichia coil and Pseudomonas fluorescens.

16. The method of claim 14, wherein said biofilm comprises two or more bacterial species.

17. The method of claim 13, wherein said biofilm comprises two or more microorganisms selected from the group consisting of bacteria, fungi, algae and archaebacteria.

18. The method of claim 11, wherein copper ion comprises a copper salt selected from the group consisting of chlorides, bromides, sulfates, acetates, formates, trichloroacetates, as well as combinations thereof.

19. The method of claim 11, wherein said quaternary ammonium compound is selected from the group consisting of Polycide®, benzalkonium chloride, cetylpyridinium chloride, cetalkonium chloride and myristalkonium chloride, or a chloride or bromide salt of a quaternary ammonium cation with the following structure: 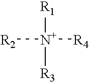
wherein R₁ is an aliphatic hydrocarbon chain (C₈-C₂₅) and R₂, R₃ and R₄ are selected from the chemical groups consisting of methyl, ethyl, n-propyl, or benzyl and combinations thereof, or wherein R₁ and R₂ are hydrocarbons that form part of a heterocyclic ring, R₃ is an aliphatic hydrocarbon chain (C₈-C₂₅), and R₄ is a chemical group consisting of methyl, ethyl, or n-propyl groups, or mixtures thereof.

20. The method of claim 11, wherein treating comprises contacting said copper ion and said quaternary ammonium compound with said surface biofilm or machine biofilm for less than four hours.

21. A method of inhibiting a biofilm comprising contacting the biofilm with copper ion and peroxide, wherein copper ion is dissolved in an aqueous solution.

22. The method of claim 21, wherein inhibiting comprises reducing microaerobic growth of organisms in said biofilm (bacteriostatic), or killing organisms in said biofilm (bacteriocidal).

23. The method of claim 21, wherein said biofilm comprises one or more microorganisms selected from the group consisting of bacteria, fungi, algae and archaebacteria.

24. The method of claim 23, wherein said biofilm comprises bacteria.

25. The method of claim 24, wherein said bacteria is selected from the group consisting of Pseudomonas aeruginosa, Staphylococcus aureus, MRSA, Staphylococcus epidermidis, Salmonella cholerasuis, Clostridium difficile, Escherichia coli and Pseudomonas fluorescens.

26. The method of claim 24, wherein said biofilm comprises two or more bacterial species.

27. The method of claim 23, wherein said biofilm comprises two or more microorganisms selected from the group consisting of bacteria, fungi, algae and archaebacteria.

28. The method of claim 21, wherein copper ion comprises a copper salt selected from the group consisting of chlorides, bromides, sulfates, acetates, formates, trichloroacetates, as well as combinations thereof.

29. The method of claim 21, wherein the peroxide is selected from the group consisting of Virox™, hydrogen peroxide, mannitol peroxide, sodium peroxide and barium peroxide, or mixtures thereof.

30. The method of claim 21, wherein (a) copper ion and said peroxide are provided in an amount that induces synergistic killing of organisms in said biofilm; and/or (b) copper ion and said peroxide are provided in amount below that which either agent can effectively kill organisms in said biofilm as single agents.

31. A method of inhibiting biofilm-induced microbial corrosion or fouling of a surface or machine comprising contacting a surface biofilm or machine biofilm with copper ion and peroxide.

32. The method of claim 31, wherein said surface or machine is comprised in an oil and gas well drilling system, a heating-cooling system, a water filtration system, a medical device (surgical tool, dental tool), a countertop, a floor, a food processing tool/equipment or paper or textile manufacturing equipment.

33. The method of claim 31, wherein said biofilm comprises one or more microorganisms selected from the group consisting of bacteria, fungi, algae and archaebacteria.

34. The method of claim 33, wherein said biofilm comprises bacteria.

35. The method of claim 34, wherein said bacteria is selected from the group consisting of Pseudomonas aeruginosa, Staphylococcus aureus, MRSA, Staphylococcus epidermidis, Salmonella cholerasuis, Clostridium difficile, Escherichia coli and Pseudomonas fluorescens.

36. The method of claim 34, wherein said biofilm comprises two or more bacterial species.

37. The method of claim 33, wherein said biofilm comprises two or more microorganisms selected from the group consisting of bacteria, fungi, algae and archaebacteria.

38. The method of claim 31, wherein copper ion comprises a copper salt selected from the group consisting of chlorides, bromides, sulfates, acetates, formates, trichloroacetates, as well as combinations thereof.

39. The method of claim 31, wherein the peroxide is selected from the group consisting of Virox™, hydrogen peroxide, mannitol peroxide, sodium peroxide and barium peroxide, or mixtures thereof.

40. A composition formulated for inhibiting a biofilm or microbial biofilm-induced corrosion or fouling of a surface or machine, said composition comprises a copper ion and Polycide® in aqueous solution.

41. A composition formulated for inhibiting a biofilm or microbial biofilm-induced corrosion or fouling of a surface or machine, said composition comprises a copper ion and benzalkonium chloride in aqueous solution.

42. A composition formulated for inhibiting a biofilm or microbial biofilm-induced corrosion or fouling of a surface or machine, said composition comprises a copper ion and cetylpyridinium chloride in aqueous solution.

43. A composition formulated for inhibiting a biofilm or microbial biofilm-induced corrosion or fouling of a surface or machine, said composition comprises a copper ion and cetalkonium chloride in aqueous solution.

44. A composition formulated for inhibiting a biofilm or microbial biofilm-induced corrosion or fouling of a surface or machine, said composition comprises a copper ion and myristalkonium chloride in aqueous solution.

45. A composition formulated for inhibiting a biofilm or microbial biofilm-induced corrosion or fouling of a surface or machine, said composition comprises a copper ion and ViroX™ in aqueous solution
